(19) United States
(12) Patent Application Publication
(10) Pub. No.: US 2019/0312346 A1
(43) Pub. Date: Oct. 10, 2019

(54) Antenna, Lighting System, And Communications System

(71) Applicant: HUAWEI TECHNOLOGIES CO., LTD., Shenzhen (CN)

(72) Inventors: Qiang WANG, Chengdu (CN); Sunjie WANG, Chengdu (CN); Jinsong WANG, Shanghai (CN); Dong YANG, Shanghai (CN); Xiongshu YI, Chengdu (CN)

(21) Appl. No.: 16/448,420

(22) Filed: Jun. 21, 2019

Related U.S. Application Data
(63) Continuation of application No. PCT/CN2017/117245, filed on Dec. 19, 2017.

(30) Foreign Application Priority Data
Dec. 23, 2016 (CN) 201611209335.X

(51) Int. Cl. H01Q 1/46; H01Q 1/24; F21V 33/00

(52) U.S. Cl. CPC H01Q 1/46; F21Y 2115/10; F21V 33/00; H01Q 1/246

(57) ABSTRACT

The present disclosure relates to antennas, lighting systems, and communications systems. One example antenna includes a radiating element and a feeding unit. The antenna is integrated with a lighting system, where the lighting system includes a protective cover and a light source disposed inside the protective cover. Both the radiating element and the feeding unit of the antenna are integrated with the protective cover of the lighting system. The radiating element is attached to a surface of a cover body of the protective cover that is in a forward direction of the light source. One part of the feeding unit is integrated with the protective cover, and is electrically connected to the radiating element, and the other part of the feeding unit supports an electrical connection to a signal processing device.

### CROSS-REFERENCE TO RELATED APPLICATIONS

This application is a continuation of International Application No. PCT/CN2017/117245, filed on Dec. 19, 2017, which claims priority to Chinese Patent Application No. 201611209335.X, filed on Dec. 23, 2016. The disclosures of the aforementioned applications are hereby incorporated by reference in their entireties.

### TECHNICAL FIELD

The present application relates to the field of communications technologies, and specifically, to an antenna, a lighting system, and a communications system.

### BACKGROUND

In a wireless communications system, an antenna is a device that implements conversion between an electromagnetic wave and an electrical signal. For a transmitter, the antenna converts an electrical signal into an electromagnetic wave, and radiates the electromagnetic wave into space. For a receiver, the antenna converts an electromagnetic wave in space into an electrical signal. In a mobile communications network, a base station is usually equipped with a pure antenna. The antenna is installed on a special communication tower, and is connected to the base station through a cable. This type of antenna often has relatively large dimensions, and radiation risks of the antenna are apt to be misunderstood by the public. Therefore, antenna and base station deployment is quite limited.

In recent years, a concept of a lamp post-mounted base station is emerging. A main characteristic of the lamp post-mounted base station is to deploy a base station or an antenna on a post of a public street lamp. A power and a coverage area of the base station and the antenna that are deployed on the lamp post are usually smaller than a power and a coverage area of a conventional base station and antenna. The base station and the antenna that are deployed on the lamp post may be designed to be miniaturized, and have relatively small dimensions. Therefore, the lamp post-mounted base station may provide more options for base station and antenna deployment.

However, to meet a requirement of base station and antenna deployment, dimensions of a lamp post are relatively large. A special lamp post often needs to be customized and designed, and an original public street lamp needs to be replaced. Therefore, existing lamp post-mounted base station deployment is still subject to certain limitations, and overall costs are relatively high.

### SUMMARY

With reference to various implementations, the present application provides an antenna, a lighting system, and a communications system, to resolve one or more disadvantages in the prior art. Particularly, solutions provided below are used to help to reduce costs, simplify deployment, or improve communication performance.

According to a first aspect, an antenna is provided. The antenna includes a radiating element and a feeding unit. The radiating element, such as a metal material that meets a radiation characteristic, is configured to perform conversion between an electromagnetic wave in space and an electrical signal in a circuit. The feeding unit, such as various electrical conductors, is configured to transfer the electrical signal between the feeding unit and the radiating element. In addition, the antenna may further include a substrate. The substrate is of a non-conductive material, is configured to support the radiating element, and can improve performance of the antenna.

When the antenna is in a transmitting state, the feeding unit feeds an electrical signal to the radiating element, and the radiating element converts the electrical signal into an electromagnetic wave, and propagates the electromagnetic wave into space. When the antenna is in a receiving state, the radiating element converts an electromagnetic wave propagated in space into an electrical signal, and transfers the electrical signal to the feeding unit.

Particularly, the antenna is integrated into a lighting system, where the lighting system includes a protective cover and a light source disposed inside the protective cover.

The lighting system is a set of hardware and software that are used for illumination, and includes but is not limited to the light source and the protective cover. The protective cover of the lighting system is a functional component, in the lighting system, that can provide a protection function for the light source. The functional component may have effects such as water tightness, moisture protection, and/or dust prevention (denoted as a physical isolation or protection effect), and on some occasions, may also have effects such as reflection, focusing, light transmission, and/or light softening (denoted as a light optimization or light distribution effect). Certainly, in addition to acting as the functional component, the protective cover of the lighting system may also have a decoration function.

The light source of the lighting system is a functional component providing an illuminating ray source in the lighting system. The light source may include one or more light emitting devices. Usually, each light emitting device can work independently, has an illuminant, a transparent lamp cover, and a related electrical interface, and can emit light after being connected to a power source.

It should be understood that, the protective cover of the lighting system is different from the transparent lamp cover of the light source. The transparent lamp cover of the light source is a part of the light emitting device, and the protective cover of the lighting system is a separate functional component, is used cooperatively with the light source, and can further provide a protection function or a light distribution function. In this application, a meaning of “transparent” is not strict, provided that a luminous flux index required by illumination is met. On some occasions, being “transparent” is also referred to as being “semitransparent” or “translucent”.

In the technical solutions of this application, a basic requirement of integrating the antenna with the lighting system is: the feeding unit of the antenna is integrated into the lighting system, and the radiating element of the antenna is attached to a surface of the protective cover, and is electrically connected to the feeding unit.

An electrical connection is any connection form for transmitting an electrical signal, and includes direct contact or electromagnetic coupling. The direct contact may include various contact manners such as fitting, welding, or conducting wire connection. It should be understood that, the protective cover of the lighting system includes at least two surfaces, where one face that is close to the light source is denoted as an inner surface, and the other face is denoted as an outer surface. The radiating element of the antenna may be attached to the inner surface of the protective cover of the lighting system, or the outer surface of the protective cover.

According to the technical solutions, the antenna is integrated into the lighting system, and this facilitates antenna deployment. In addition, the radiating element of the antenna is attached to the surface of the protective cover of the lighting system, so that the antenna can be decoupled from the light source of the lighting system, facilitating production, installation, or replacement, and reducing costs. The word “decoupled” may be understood as being independent, being not bound, or being not integrated.

A position relative to the light source is used as a classification criterion. The protective cover of the lighting system may be classified into a protective cover in a forward direction of the light source and a protective cover in another direction (a non-forward direction) of the light source. The forward direction of the light source may be understood as an illumination direction of the lighting system or the light source, that is, a direction in which illuminating ray goes forward. A forward side direction of the light source is relatively special, and on some occasions, the forward side direction is also considered as being included in the forward direction of the light source. Other components (such as a power supply apparatus and a heat dissipation apparatus) of the lighting system are usually located inside the protective cover of the lighting system, and are usually located in the non-forward direction of the light source.

With reference to the foregoing technical solutions, in an optional technical solution, the radiating element of the antenna is attached to a surface of the protective cover, of the lighting system, in a forward direction of the light source. The optional solution helps to reduce interference from the light source and another component of the lighting system to an electromagnetic wave radiated or received by the antenna, and improve a communication performance of the antenna.

The protective cover in the forward direction of the light source includes at least two surfaces, where one surface is closer to an illuminated object. With reference to the foregoing technical solutions and the optional technical solution, in an optional technical solution, the radiating element of the antenna is attached to the surface, of the protective cover of the lighting system, that is close to the illuminated object. Therefore, the protective cover does not obstruct the electromagnetic wave radiated or received by the antenna. This helps to improve communication performance of the antenna.

The protective cover of the lighting system may be classified into two types: an enclosed protective cover and a non-enclosed protective cover. The enclosed protective cover has no obvious opening, and the non-enclosed protective cover has an obvious opening. The “enclosed” herein is not absolutely enclosed in a strict sense, provided that enclosed performance required for normal working of the lighting system is met. Generally, the enclosed protective cover can provide a better protection effect. The non-enclosed protective cover can provide light distribution effects such as light focusing and reflection, and often needs to be cooperatively used with the light source, of the lighting system, that has a good protection effect. The enclosed protective cover is widely used, and a shape thereof is not limited. The non-enclosed protective cover is often used for top-to-bottom illumination, and a common cover body may be cone-shaped, columnar, or bowl-shaped.

With reference to the foregoing technical solutions and the optional technical solutions, in an optional technical solution, the radiating element of the antenna is attached to the inner surface of the protective cover. According to the optional solution, the radiating element of the antenna may share the protection effect provided by the protective cover of the lighting system, so that durability of the antenna is improved, and communication performance of the antenna is ensured. The optional solution is often applied to the non-enclosed protective cover, but a possibility of being applied to the enclosed protective cover is not excluded. In another optional technical solution, the radiating element of the antenna is attached to the outer surface of the protective cover. According to the optional solution, electromagnetic interference from the protective cover of the lighting system can be reduced, and a radiation characteristic of the antenna can be improved, thereby improving communication performance of the antenna. The optional solution is often applied to the enclosed protective cover, but a possibility of being applied to the non-enclosed protective cover is not excluded.

With reference to the foregoing technical solutions and the optional technical solutions, a protection material may further cover an outer surface of the radiating element of the antenna. In other words, in an optional technical solution, one face of the radiating element of the antenna is attached to the surface of the protective cover, and the other face is covered with the protection material. The protection material may also be used to provide a protection effect of physical isolation, thereby further improving durability of the antenna and ensuring communication performance of the antenna.

With reference to the foregoing technical solutions and the optional technical solutions, the substrate of the antenna may be designed as a part of the protective cover of the lighting system, and the cover body part to which the radiating element is attached is of a non-conductive material, and is disposed as the substrate of the antenna. Therefore, a separate antenna substrate does not need to be disposed, thereby further improving an integration level between the antenna and the lighting system.

In an optional technical solution, a part or a whole of the cover body of the protective cover of the lighting system is of a non-metal material, and the cover body of the non-metal material is disposed as the substrate of the antenna. In another optional technical solution, a dielectric layer of a non-metal material is attached to the surface of the protective cover of the lighting system, and the dielectric layer is disposed as the substrate of the antenna. The dielectric layer is located between the cover body of the protective cover and the radiating element of the antenna.

With reference to the foregoing technical solutions and the optional technical solutions, the radiating element of the antenna may also be integrated with the protective cover of the lighting system. A shape of the radiating element fits a shape of the protective cover, so that impact on an illumination effect is reduced, or a radiation characteristic of the antenna is improved.

In an optional technical solution, an overall outline of the radiating element of the antenna may be of a regular shape with a geometric center, including a cross, a polygon, a circle, an oval, or the like. On this basis, an inside or an edge of the radiating element is hollowed out, and the transparent lamp cover of the light source or a translucent cover body of the lighting system may be embedded into a hollowed-out part, so that illuminating ray passes through. In another optional technical solution, the radiating element of the antenna is of an irregular shape, so that the illuminating ray is not blocked. When the optional solutions are used, impact of the antenna on an illumination effect can be reduced.

With reference to the foregoing technical solutions and the optional technical solutions, in an optional technical solution, one or more plated holes are disposed on a surface of the radiating element of the antenna, and are used for grounding of the radiating element. The plated hole, also referred to as a hole plated or a via hole, is a hole with an inner wall covered by a conducting metal layer, and is usually used for connection between a plurality of layers of printed wiring. With the plated hole, the radiating element can be grounded (electrically connected to a reference ground), and can generate one or more currents vertical to the radiating element, to expand a radiation range. When a position of the plated hole is properly designed, omnidirectional radiation can even be formed. Therefore, the optional solution can be used to improve a radiation characteristic of the antenna, thereby improving communication performance of the antenna.

On this basis, in an optional technical solution, the radiating element is in a regular geometric shape with a geometric center. On this basis, at least two of a plurality of plated holes are symmetrically distributed around the geometric center of the radiating element. Further, there may be an even number of plated holes, and pairs of plated holes are symmetrically distributed around the center. In addition, each plated hole may be disposed in a position that is on a line between an edge and the geometric center and that is closer to the edge.

With reference to the foregoing technical solutions and the optional technical solutions, the feeding unit of the antenna may also be integrated with the protective cover, and there are various optional technical solutions. Generally, the feeding unit of the antenna may also be attached to the surface on which the radiating element is located; or is in direct contact with the radiating element by using a metal conductor that passes through the protective cover; or may be electrically connected to the radiating element of the antenna in an electromagnetic coupling manner. When the antenna is working, the feeding unit needs to be electrically connected to a signal processing device.

It should be understood that, the signal processing device is a device that is configured to process an electrical signal, and is different from the antenna. For the antenna, the signal processing device may be considered as a signal source of the antenna (in a transmitting state) or a signal destination (in a receiving state). The signal processing device can generate an electrical signal to be sent by the antenna, or process an electrical signal that has been received by the antenna, where the processing may include operations such as filtering and amplification. For example, the signal processing device may be a base station or a remote radio unit in a mobile communications network.

In an optional technical solution, the feeding unit includes a metal conductor, which is denoted as a feeding metal conductor. The feeding metal conductor may be a metal sheet (denoted as a feeding metal sheet), a metal probe, or a plated hole, or the like that is used for feeding. There is a gap in the cover body to which the radiating element is attached, and the feeding metal conductor is disposed in the gap. An outline of the gap is not limited, and may be linear, hole-shaped, or the like. The feeding metal conductor passes through the cover body via the gap, one end is in direct contact with the radiating element, and the other end supports an electrical connection to a signal transmission line. The signal transmission line is configured to transmit an electrical signal between the feeding metal conductor and the signal processing device.

On this basis, in an implementation, the feeding metal conductor is a feeding metal sheet, the signal transmission line is a coaxial line, and the coaxial line includes an outer conductor and an inner conductor that are coaxial, where the outer conductor of the coaxial line is used for grounding, one end of the inner conductor of the coaxial line is in direct contact with the feeding metal sheet, and the other end of the inner conductor of the coaxial line supports an electrical connection to the signal processing device.

In another implementation, the feeding metal conductor is a feeding metal sheet, the signal transmission line is a microstrip, and the microstrip includes a signal layer, a dielectric layer, and a ground plane that are sequentially attached, where

the ground plane of the microstrip is used for grounding, the signal layer of the microstrip includes a conductor strip, one end of the conductor strip is in direct contact with the feeding metal sheet, and the other end of the conductor strip supports an electrical connection to the signal processing device.

Grounding means being electrically connected to a reference ground of the antenna. During implementation, the reference ground of the antenna may be the same as a reference ground of the signal processing device, that is, a grounding apparatus is shared.

With reference to the foregoing technical solutions and the optional technical solutions, in an optional technical solution, the feeding metal sheet is disposed in the gap at an angle vertical to the radiating element. Further, the feeding metal sheet of the feeding unit may be of an axisymmetric structure, and the feeding metal sheet is disposed in the gap at an angle at which a central axis is vertical to the radiating element. The solution is used to implement feeding at a vertical angle. This helps to improve performance of the antenna. In addition, the metal conductor may be in a gradually-changed shape such as a trapezoid, and a cross sectional area of the conductor increases along a direction from the coaxial line or the microstrip to the radiating element. This helps to further improve performance of the antenna.

With reference to the foregoing technical solutions and the optional technical solutions, in an optional technical solution, the feeding unit includes a feeding panel, and the feeding panel is disposed on the other surface of the cover body to which the radiating element is attached, where the feeding panel includes a dielectric layer, a ground plane is attached to each of two surfaces of the dielectric layer, and there is a gap in the ground plane that is close to the radiating element; and the dielectric layer includes a conductor strip, one end of the conductor strip abuts the gap, and the other end of the conductor strip supports an electrical connection to the signal processing device. An outline of the gap is not limited, and may be linear, hole-shaped, or the like.

With reference to the foregoing technical solutions and the optional technical solutions, in an optional technical solution, the radiating element is attached to an inner surface of the cover body of the protective cover that is in the forward direction of the light source, the feeding unit includes a conductor strip, and is also attached to the inner surface of the cover body, one end of the conductor strip is in direct contact with the radiating element, and the other end of the conductor strip supports an electrical connection to the signal processing device. A stripline may be a part of a microstrip. In this case, the protective cover to which the stripline is attached may be used as a dielectric layer of the microstrip. According to the optional solution, the feeding unit of the antenna occupies a small area, and is easy to produce and install.

In contrast, herein, the feeding unit can be in direct contact with the radiating element by using the metal conductor embedded into the protective cover of the lighting system. This helps to ensure a feeding effect, and improve performance of the antenna. A separate feeding panel is used for the feeding unit, so that the feeding panel can be decoupled from the signal transmission line. This helps to improve antenna design flexibility, and improve engineering structure stability of the antenna. The feeding unit performs feeding to the radiating element in a coupling manner, or the feeding unit and the radiating element are located on a same surface of the protective cover. In both the manners, trepanning or slotting on the protective cover is not required. This helps to reduce production costs, and improve engineering structure stability of the antenna.

With reference to the foregoing technical solutions and the optional technical solutions, in an optional technical solution, the antenna is integrated into the lighting system in which a light emitting diode is used as the light source. Optionally, the antenna may further share a heat dissipation apparatus and/or a grounding apparatus with the lighting system. In the lighting system in which the light emitting diode is the light source, a heating value of the lighting system is relatively small. This helps to ensure performance of the antenna. Sharing the heat dissipation device and/or the grounding apparatus with the lighting system helps to further improve the integration level between the antenna and the lighting system.

With reference to the foregoing technical solutions and the optional technical solutions, in an optional technical solution, the signal processing device is a radio frequency processing unit used for mobile communication, and a part of the feeding unit of the antenna supports an electrical connection to the radio frequency processing unit used for mobile communication. Because an antenna coverage area and a power required by the radio frequency processing unit used for mobile communication are usually higher than those in common wireless communication (such as a wireless local area network), there is a special requirement for a communications interface, for example, a common public radio interface (CPRI) is required. According to the technical solution, a part of the feeding unit of the antenna supports an electrical connection to the radio frequency processing unit used for mobile communication, and can be adapted to the communications interface of the radio frequency processing unit used for mobile communication. For example, the feeding unit of the antenna includes a communications interface that is configured to support an electrical connection to the signal processing device.

According to a second aspect, a lighting system is provided, including lighting sub-systems and an antenna, where the lighting sub-system includes a protective cover and a light source disposed inside the protective cover, and the antenna includes a radiating element and a feeding unit, where

the feeding unit of the antenna is integrated onto the protective cover of the lighting system; and

the radiating element of the antenna is attached to a surface of a cover body, in a forward direction of the light source, of the protective cover of the lighting system, and the cover body part to which the radiating element is attached is of a non-conductive material, and is disposed as a substrate of the antenna.

With reference to the foregoing technical solutions, in an optional technical solution, there is a gap in the cover body of the protective cover, the gap is configured to arrange a feeding metal conductor, a signal transmission line is attached to an inner surface of the protective cover, and both the feeding metal conductor and the signal transmission line belong to the feeding unit of the antenna, where the feeding metal conductor passes through the cover body via the gap, one end is in direct contact with the radiating element, and the other end is in direct contact with the signal transmission line.

With reference to the foregoing technical solutions and the optional technical solution, in an optional technical solution, feeding is performed in a coupling manner. A feeding panel is disposed on the other surface of the cover body to which the radiating element is attached, and the feeding panel belongs to the feeding unit of the antenna, where the feeding panel includes a dielectric layer, a ground plane is attached to each of two surfaces of the dielectric layer, and there is a gap in the ground plane that is close to the radiating element; and the dielectric layer includes a conductor strip, one end of the conductor strip abuts the gap, and the other end of the conductor strip supports an electrical connection to a signal processing device.

With reference to the foregoing technical solutions and the optional technical solutions, in an optional technical solution, the radiating element and the feeding unit of the antenna are attached to an inner surface of the cover body of the protective cover that is in the forward direction of the light source, the feeding unit includes a conductor strip, one end of the conductor strip is in direct contact with the radiating element, and the other end of the conductor strip supports an electrical connection to the signal processing device.

With reference to the foregoing technical solutions and the optional technical solutions, in an optional technical solution, at least one plated hole is further disposed in the cover body to which the radiating element is attached, and a conducting metal layer covers an inner wall of the plated hole, and is used for grounding of the radiating element.

With reference to the foregoing technical solutions and the optional technical solutions, in an optional technical solution, a light source of the lighting sub-system is a light emitting diode, and the lighting sub-system shares a heat dissipation apparatus with the antenna.

According to a third aspect, a communications system is provided, including a signal processing device and an antenna.

The antenna is integrated with a lighting system, where the lighting system includes a protective cover and a light source disposed inside the protective cover; both a radiating element and a feeding unit of the antenna are integrated with the protective cover of the lighting system, where the radiating element is attached to a surface of a cover body, in a forward direction of the light source, of the protective cover; and one part of the feeding unit is integrated with the protective cover, and is electrically connected to the radiating element, and the other part of the feeding unit is electrically connected to the signal processing device.

The antenna may be any one of the antennas provided in the first aspect, and the signal processing device may be a radio frequency processing unit used for mobile communication.

According to a fourth aspect, a communications system is provided, including a signal processing device and a lighting system. The signal processing device is integrated into the lighting system, and the signal processing device is electrically connected to an antenna that is integrated into the lighting system. The antenna may be any one of the antennas provided in the first aspect, and the lighting system may be any one of the lighting systems provided in the second aspect.

It should be understood that, the technical solutions and the optional technical solutions provided in the second to the fourth aspects are the same or similar to many technical features of the technical solutions and the optional technical solutions provided in the first aspect, and technical effects are also the same or similar. Details are not described again.

### BRIEF DESCRIPTION OF DRAWINGS

FIG. 1-1 to FIG. 1-4 each are a schematic structural diagram of a lighting system according to an embodiment of the present invention;

FIG. 2-1 to FIG. 2-3 each are a schematic diagram of an antenna deployment architecture according to an embodiment of the present invention;

FIG. 3-1 to FIG. 3-6 each are a schematic structural diagram of an antenna according to an embodiment of the present invention;

FIG. 4-1 to FIG. 4-5 each are a schematic structural diagram of an antenna according to an embodiment of the present invention;

FIG. 5-1 to FIG. 5-4 each are a schematic structural diagram of an antenna according to an embodiment of the present invention;

FIG. 6-1 to FIG. 6-3 each are a schematic structural diagram of an antenna according to an embodiment of the present invention;

FIG. 7-1 to FIG. 7-3 each are a schematic structural diagram of an antenna according to an embodiment of the present invention;

FIG. 8 is a schematic structural diagram of a feeding manner of an antenna according to an embodiment of the present invention;

FIG. 9 is a schematic structural diagram of another feeding manner of an antenna according to an embodiment of the present invention;

FIG. 10 is a schematic structural diagram of still another feeding manner of an antenna according to an embodiment of the present invention;

FIG. 11 is a schematic structural diagram of yet another feeding manner of an antenna according to an embodiment of the present invention;

FIG. 12 is a schematic structural diagram of a lighting system according to an embodiment of the present invention;

FIG. 13 is a schematic structural diagram of a communications system according to an embodiment of the present invention; and

FIG. 14 is a schematic structural diagram of another communications system according to an embodiment of the present invention.

It should be understood that, in the foregoing schematic structural diagrams, dimensions and shapes of modules are for reference only, and shall not constitute the only interpretation of the embodiments of the present invention. A relative position between the modules presented in the schematic structural diagrams represents only an example of a structural correlation between the modules, but does not limit a physical connection manner in the embodiments of the present invention. In addition, it is impossible and unnecessary to present all possible modules in the schematic structural diagrams. Therefore, if a specific module is not presented in a figure, it should not be construed that the module cannot be included in the embodiments of the present invention.

### DESCRIPTION OF EMBODIMENTS

To make the objectives, technical solutions, and advantages of the present application clearer, the following further describes the technical solutions provided in the present application in detail with reference to the accompanying drawings and the embodiments.

A deployment environment and a performance requirement of an antenna are critical to design of the antenna. When the antenna is integrated into a lighting system, the lighting system becomes a part of the deployment environment of the antenna. In different application scenarios, the lighting system has various types and shapes. Therefore, in the embodiments of the present invention, there are a plurality of feasible solutions for integrating the antenna with the lighting system. The following describes the plurality of feasible solutions in the embodiments of the present invention in detail with reference to a plurality of application scenarios of the lighting system.

The lighting system is a set of hardware and software that are used for illumination, and includes but is not limited to a light source and a protective cover. The protective cover of the lighting system is a functional component providing a protection function in the lighting system. The functional component may have effects such as water tightness, moisture protection, or dust prevention (denoted as a physical isolation or protection effect), and on some occasions, may further have effects such as focusing, reflection, blocking, or light softening (denoted as a light optimization or light distribution effect). Moreover, in addition to acting as the functional component, the protective cover of the lighting system may have a decoration function. The light source of the lighting system is a functional component providing an illuminating ray source in the lighting system. The light source may include one or more light emitting devices. Usually, each light emitting device can work independently, has an illuminant, a transparent lamp cover, and a related electrical interface, and can emit light after being connected to a power source.

It should be understood that, the protective cover of the lighting system is different from the transparent lamp cover of the light source. The transparent lamp cover of the light source is a part of the light emitting device. In contrast, the protective cover of the lighting system is a separate functional component, is used cooperatively with the light source, and can further provide a protection function or a light distribution function. For example, a glass bulb of an incandescent lamp is a part of the incandescent lamp, and the glass bulb is not a separate functional component, and should be considered as the transparent lamp cover of the light source. If the incandescent lamp is further equipped with an inverted bowl-shaped reflecting cover, the reflecting cover is considered as the protective cover of the lighting system, and the incandescent lamp is considered as the light source of the lighting system.

The protective cover of the lighting system may be classified into an enclosed protective cover and a non-enclosed protective cover. The enclosed protective cover has no obvious opening, and the non-enclosed protective cover has an obvious opening. The “enclosed” herein is not absolutely enclosed, provided that enclosed performance required for normal working of the lighting system is met. Generally, the enclosed protective cover can provide a better protection effect. The non-enclosed protective cover can provide light distribution effects such as light focusing and reflection, and often needs to be cooperatively used with the light source, of the lighting system, that has a good protection effect. The enclosed protective cover is widely used, and a shape thereof is not limited. The non-enclosed protective cover is often used for top-to-bottom illumination, and a common cover body may be inverted cone-shaped, bowl-shaped, or columnar.

For the enclosed protective cover, the cover body part in a forward direction of the light source is usually of a transparent material. If the cover body part is of a non-transparent material, the cover body part needs to be closely attached to the transparent lamp cover of the light source, to form enclosed space together. For the non-enclosed protective cover, the opening on the cover body is usually located in the forward direction of the light source, so that illuminating ray of the light source passes through. The forward direction of the light source may be understood as an illumination direction of the light source, that is, a direction in which illuminating ray goes forward.

For the lighting system, an illumination direction and an illumination range are important indicators, and basically determine an application scenario of the lighting system. For example, in terms of the illumination direction, the lighting system may be classified into a directional lighting system and a non-directional lighting system. The directional lighting system is a lighting system that has a main illumination direction. Correspondingly, a lighting system that has no main illumination direction is referred to as a non-directional lighting system. In a specified space range of the main illumination direction, an effective luminous flux of the lighting system should account for at least a half of all luminous fluxes. The specified space range may be denoted as a main illumination range.

For example, if an effective luminous flux of a lighting system in a 120° cone solid angle range in a main illumination direction is greater than 80% of all luminous fluxes, the lighting system is referred to as a directional lighting system, and the 120° cone solid angle range may be denoted as a main illumination range of the lighting system. It should be understood that, the value herein is only an example, and there may be another definition for the main illumination range. For detailed content, refer to industry knowledge in the field of lighting technologies. No more details are provided in this application. In addition, directional lighting and non-directional lighting are differentiated mainly for convenience of description, and should not be interpreted as the only application scenario of the embodiments of the present invention.

For the directional lighting, in a common application scenario, the light source of the lighting system is placed in a high position, such as on a lamp post or a ceiling, and the main illumination direction is from top to bottom. In some application scenarios, the light source of the lighting system is placed in a low position, such as being embedded into a floor, and the main illumination direction is from bottom to top. A feature of the directional lighting system is that the lighting system has a light focusing or reflection function, and illuminating ray transmits along the main illumination direction after light focusing or reflection. The protective cover of the lighting system often blocks or reflects some illuminating ray.

For the non-directional lighting, the lighting system has no specific illumination direction, and may be approximately considered as a point light source. A common example of the point light source is a pendulous incandescent lamp bulb. A feature of the non-directional lighting system is that the lighting system has no obvious light focusing or reflection function, and the transparent lamp cover of the light source or the protective cover of the lighting system does not obviously block illuminating ray of the light source.

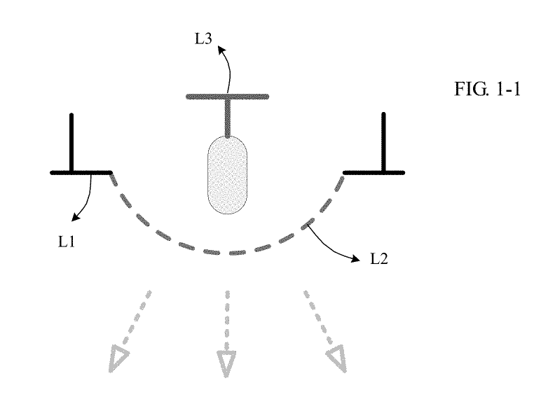

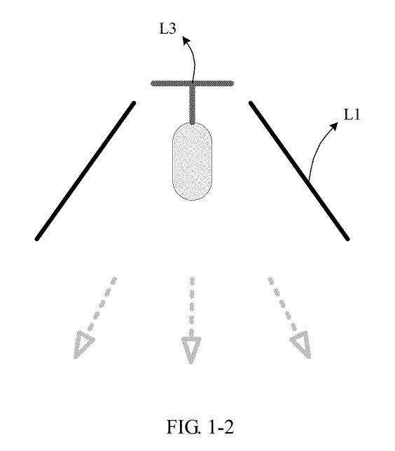

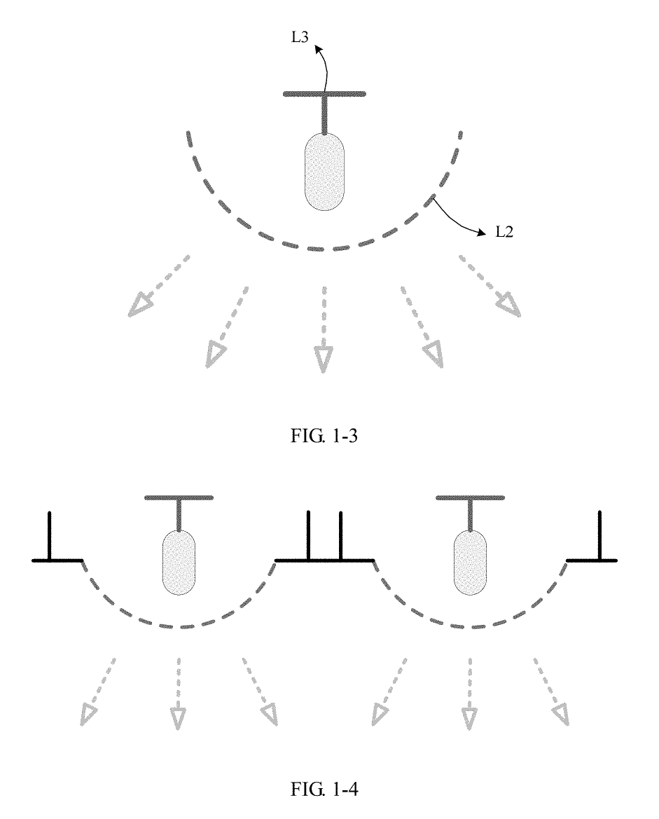

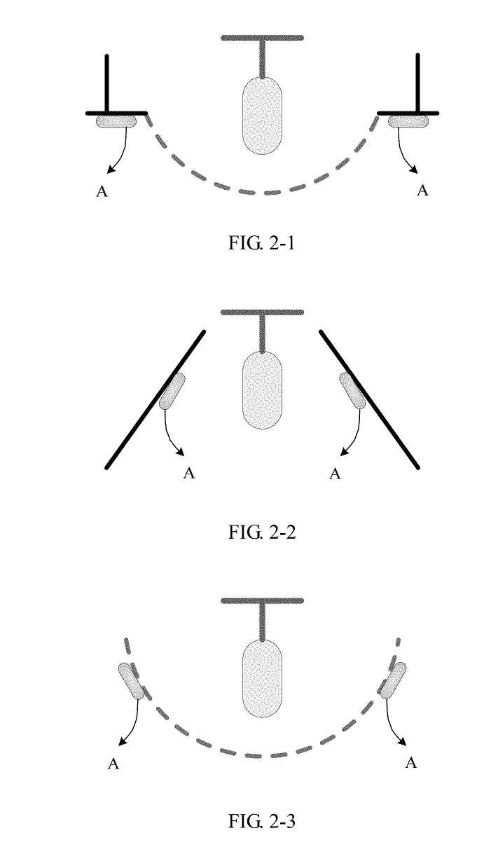

FIG. 1-1 to FIG. 1-3 each are a schematic structural diagram of a lighting system according to an embodiment of the present invention, and show basic structures of three types of typical lighting systems. The lighting system is used as an antenna deployment environment in this embodiment of the present invention. The lighting systems shown in FIG. 1-1 and FIG. 1-2 are in a directional lighting state, and the lighting system shown in FIG. 1-3 is in a non-directional lighting state.

In FIG. 1-1, a module L1 and a module L2 each represent a cover body of the lighting system, and are respectively denoted as a cover body L1 and a cover body L2. A module L3 represents a light source of the lighting system, and is denoted as a light source L3. The cover body L1 is of a non-transparent material, and mainly has a protection effect. The cover body L2 is of a transparent material, so that illuminating ray passes through. It should be understood that in this application, a meaning of “transparent” is not strict, provided that a luminous flux index required by illumination is met. On some occasions, being “transparent” is also referred to as being “semitransparent” or “translucent”. When the cover body L1 and the cover body L2 need to be distinguished, the cover body L1 and the cover body L2 may be further denoted as a protection cover body L1 and a translucent cover body L2. Similarly, the lighting system shown in FIG. 1-2 includes a protection cover body L1 and a light source L3, and the lighting system shown in FIG. 1-3 includes a translucent cover body L2 and a light source L3.

As shown in FIG. 1-1, illuminating ray emitted by the light source L3 is blocked or reflected by the protection cover body L1, and irradiates downward after passing through the translucent cover body L2. Therefore, the lighting system is in a directional lighting state. As shown in FIG. 1-2, illuminating ray emitted by the light source L3 is blocked or reflected by the protection cover body L1, and irradiates downward. Therefore, the lighting system is also in a directional lighting state. As shown in FIG. 1-3, illuminating ray emitted by the light source L3 is not obviously blocked by the translucent cover body L2, and irradiates in all directions after passing through the translucent cover body L2. Therefore, the lighting system is in a non-directional lighting state.

It should be noted that, the cover body L1 is a part of a protective cover of the lighting system. The cover body L2 may be a part of the protective cover of the lighting system, or may be a part of the light source, that is, may act as a transparent lamp cover of the light source. For example, when the cover body L2 and the cover body L1 are designed or manufactured as a whole, and form a relatively independent entity, the cover body L2 is a part of the protective cover of the lighting system. When the cover body L2 and a light emitting device that is included in the light source are designed or manufactured as a whole, and form a relatively independent entity, the cover body L2 is the transparent lamp cover of the light source.

A feature of the lighting system shown in FIG. 1-1 is that, a cover body in a forward direction of the light source includes both the protection cover body L1 and the translucent cover body L2. In addition, the protection cover body L1 and the translucent cover body L2 closely fit, to form enclosed space in the forward direction of the light source. Particularly, an inner surface of the protection cover body L1 is close to the light source, and an outer surface of the protection cover body L1 is in open space, and is closer to an illuminated object than the inner surface of the protection cover body L1.

In actual application, a common example of this type of lighting system is a light emitting diode (LED) lighting system, and particularly a panel-type LED lighting system including a plurality of LED lamp beads. In the panel-type LED lighting system, each LED lamp bead is considered as an independently working light emitting device (with a transparent lamp cover). A plurality of LED lamp beads are embedded into a panel, and are combined to form a light source of a specific shape (a rectangle, a circle, or the like). The panel between the LED lamp beads is usually of a non-transparent material, and this part of panel is considered as a part (that is, the protection cover body L1) of the protective cover of the lighting system. If a position in which an LED lamp bead is embedded into the panel is covered by a transparent panel, this part of transparent panel is considered as the translucent cover body L2. In this case, the translucent cover body L2 is also a part of the protective cover of the lighting system. If a position in which an LED lamp bead is embedded into the panel is not covered by a panel, a transparent lamp cover of the LED lamp bead is considered as the translucent cover body L2.

A feature of the lighting system shown in FIG. 1-2 is that, a cover body in a forward direction of the light source includes the protection cover body L1 of a special shape. As shown in FIG. 1-2, upper parts of the protection cover body L1 get closer, lower parts get farther from each other and form an opening, and both an inner surface and an outer surface of the protection cover body at the opening are located in open space. Particularly, the inner surface of the protection cover body L1 is close to the light source, and is closer to an illuminated object than the outer surface of the protection cover body L1. In actual application, a common example of this type of lighting system is a lamp equipped with a reflecting cover, and the reflecting cover has a shape similar to that of the protection cover body L1 shown in FIG. 1-2, for example, a cone shape or a bowl shape. On some occasions, a columnar reflecting cover may also be considered as a special case of this type of lighting system.

A feature of the lighting system shown in FIG. 1-3 is that, a cover body in a forward direction of the light source includes the translucent cover body L2. As shown in FIG. 1-3, an inner surface of the translucent cover body L2 is close to the light source, and an outer surface of the translucent cover body L2 is in open space, and is closer to an illuminated object than the inner surface of the translucent cover body. In actual application, a common example of this type of lighting system is a globular street lamp or a transparent cylinder street lamp without a reflecting cover. On some occasions, an indoor ceiling light may also be considered as a special case of this type of lighting system.

It should be noted that, although the light source L3 in FIG. 1-1 to FIG. 1-3 represents one light emitting device, the lighting system to which this embodiment of the present invention is applicable is not limited thereto. In actual application, the light source L3 apparently may include a plurality of light emitting devices. For example, similar to FIG. 1-1, FIG. 1-4 is also a schematic structural diagram of a lighting system according to an embodiment of the present invention. FIG. 1-4 shows two light emitting devices, and the two light emitting devices may be understood as representing two light sources, or may be understood as representing two light emitting devices that constitute one light source. In addition, it should be understood that, each of the lighting systems shown in FIG. 1-1 to FIG. 1-4 may be considered as a part of a larger lighting system.

FIG. 2-1 to FIG. 2-3 each are a schematic diagram of an antenna deployment architecture according to an embodiment of the present invention, and show antenna deployment positions in the foregoing three types of lighting systems, respectively. It should be understood that the schematic diagram of the antenna deployment architecture focuses on showing the antenna deployment architecture, but does not need to show a structure detail of an antenna. Therefore, the antenna deployment architecture is shown and described herein by using an example of a position in which a radiating element of the antenna is integrated into a lighting system. An inner structural feature of the antenna will be further detailed in the following description with reference to other accompanying drawings.

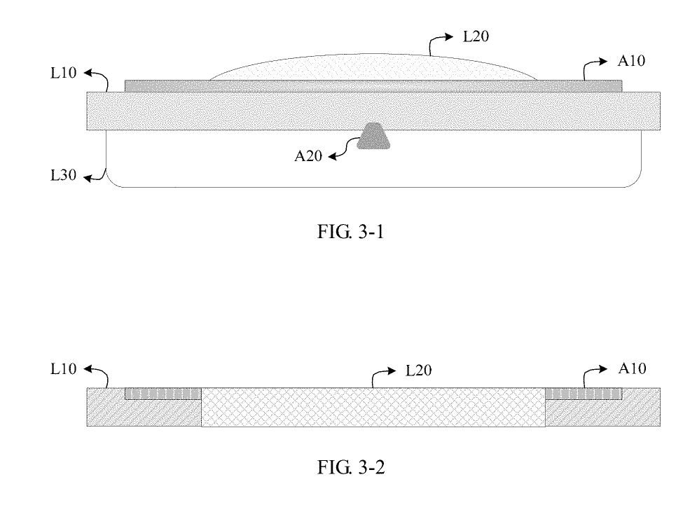

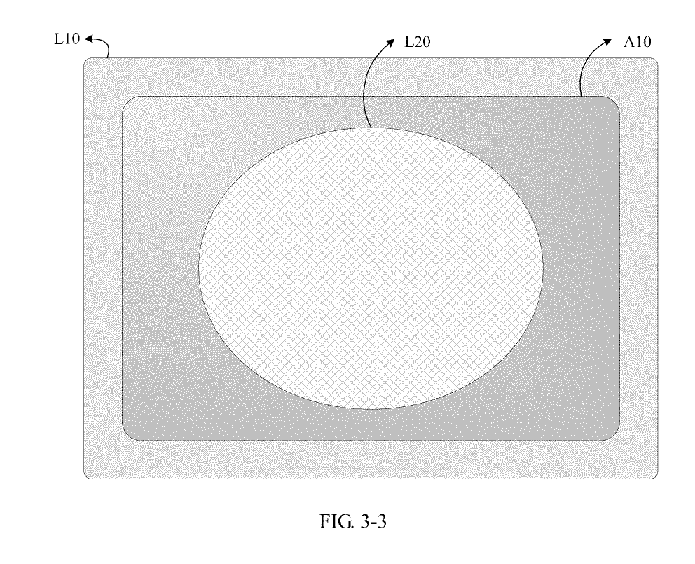

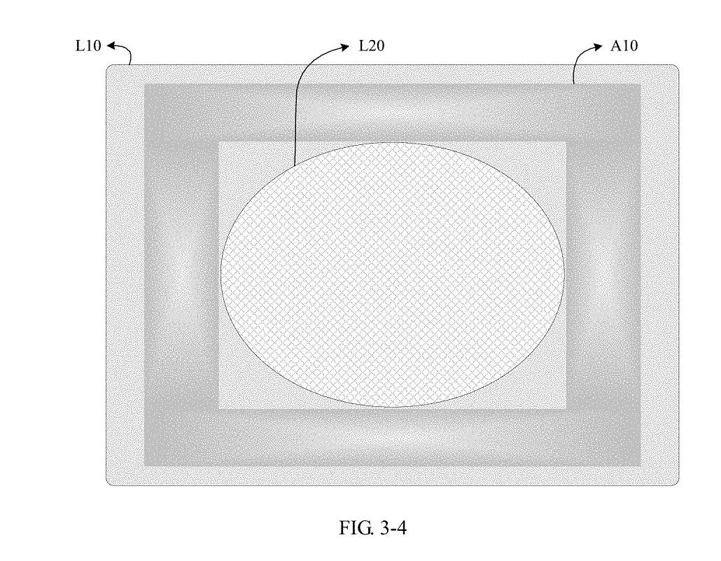

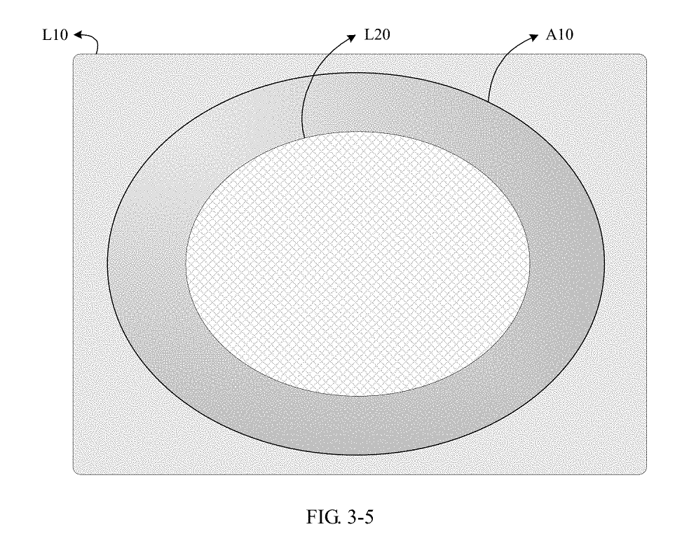

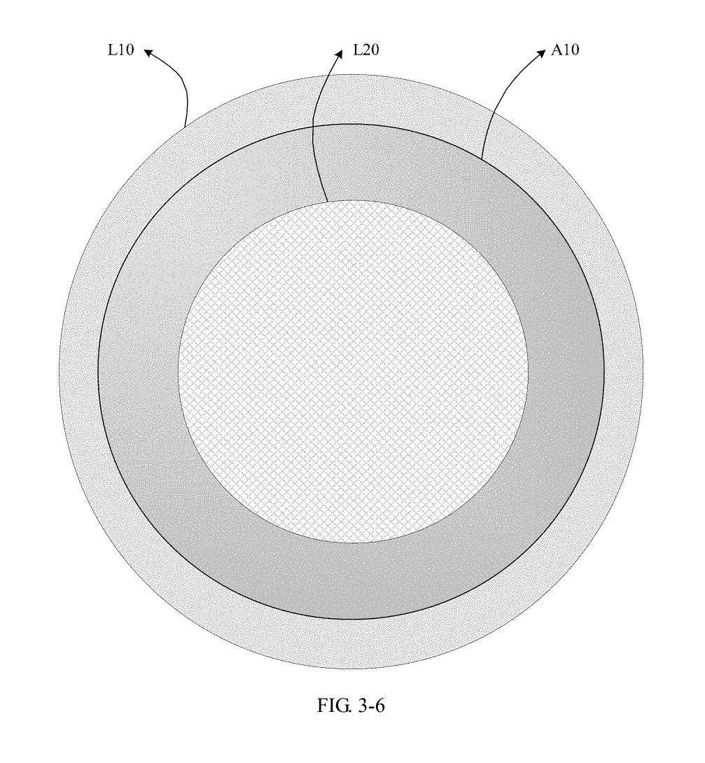

As shown in FIG. 2-1, an antenna is deployed on an outer surface of a protective cover of a lighting system, and additionally, is on an outer surface of a protection cover body in a forward direction of a light source. As shown in FIG. 2-2, an antenna is deployed on an inner surface of a lighting system, and additionally, is on an inner surface of a protection cover body in a forward direction of a light source. As shown in FIG. 2-3, an antenna is deployed on an outer surface of a protective cover of a lighting system, and additionally, is on an outer surface of a translucent cover body in a forward direction of a light source. It is not hard to find that, all the deployment positions of the antenna in the lighting system are on a surface, of the protective cover of the lighting system, that is close to an illuminated object.

In conclusion, in this embodiment of the present invention, the antenna is integrated onto the protective cover of the lighting system. Because the antenna is integrated with the protective cover of the lighting system, the antenna can be decoupled from the light source or another component of the lighting system. This facilitates installation and replacement of the antenna, thereby reducing costs and/or improving communication performance. In addition, the deployment position of the antenna in the lighting system is on the surface, of the protective cover of the lighting system, that is close to the illuminated object, and the protective cover does not obstruct an electromagnetic wave radiated or received by the antenna. Therefore, the technical solutions help to improve communication performance of the antenna.

FIG. 3-1 to FIG. 3-6 each are a schematic structural diagram of an antenna according to an embodiment of the present invention. The antenna may be applied to the antenna deployment architecture shown in FIG. 2-1. FIG. 3-1 is a side view of an overall structure of the antenna, FIG. 3-2 is a side sectional view of a partial structure of the antenna, and FIG. 3-3 to FIG. 3-6 each are a top view of an overall structure of the antenna. It should be understood that, the schematic structural diagrams show, in different forms, various structural features of the antenna. Unless otherwise expressly stated, the accompanying drawings are not limited to representing an antenna of a single physical shape. With reference to the schematic structural diagrams, the following describes an inner structural feature of the antenna in the deployment architecture, and particularly a structural feature of a radiating element.

In FIG. 3-1, a module A10 represents a radiating element of the antenna, and is denoted as a radiating element A10. A module A20 represents a feeding unit of the antenna, and is denoted as a feeding unit A20. A module L10 and a module L20 each represent a cover body of a lighting system, and are respectively denoted as a cover body L10 and a cover body L20. A module L30 represents other components of the antenna and the lighting system, for example, a power supply apparatus, a heat dissipation apparatus, a light source, a light distribution apparatus, and another cover body. For simplicity, the light source of the lighting system is not drawn separately.

Similar to the lighting system shown in FIG. 1-1, the cover body L10 may be further denoted as a protection cover body L10, and is a part of a protective cover of the lighting system. The cover body L20 may be further denoted as a translucent cover body L20, and may be a part of the protective cover of the lighting system, or may be a part of the light source, that is, may act as a transparent lamp cover of the light source. Although only one cover body L20 is shown in FIG. 3-1, it should be understood that in this embodiment of the present invention, a quantity of cover bodies L20 is not limited, and there may be one or more cover bodies L20. The lighting system and the antenna shown in FIG. 3-1 may be considered as a part of a lighting system and an antenna that have a plurality of cover bodies L20.

In addition, there may be one or more light emitting devices that constitute the light source. The light emitting device of the light source is disposed in inner space formed by the cover body L10, the cover body L20, and the module L30. Illuminating ray of the light emitting device directionally transfers through the cover body L20 by using a reflection or focusing effect of the light distribution apparatus (such as L10, L20, or L30). The module L30 may also represent a partial cover body of the lighting system. When L10 and L20 need to be distinguished from the partial cover body represented by the module L30, L10 and L20 are denoted as cover bodies in a forward direction of the light source, and the partial cover body represented by the module L30 is denoted as a cover body in another direction of the light source.

For example, when the cover body L20 is the transparent lamp cover of the light source, the light emitting device of the light source is disposed inside the cover body L20. When the cover body L20 is a part of the protective cover of the lighting system, the light emitting device of the light source is disposed below the cover body L10 or L20 and above the module L30. When the lighting system is positioned as shown in FIG. 3-1, illuminating ray of the light source irradiates upward through the cover body L20. In this case, a main illumination direction of the lighting system is from bottom to top, and the cover bodies L10 and L20 in the forward direction of the light source are located above the light source. It should be understood that, the top and bottom herein are not in a physical sense, and only represent a relative position relationship between modules. In a real application scenario, the main illumination direction of the lighting system or the forward direction of the light source may be from top to bottom, from bottom to top, or another direction. When the lighting system is positioned as shown in FIG. 2-1, the main illumination direction is from top to bottom.

As shown in FIG. 3-1, the radiating element A10 is disposed on an outer surface of the cover body L10. Because the radiating element of the antenna is disposed on an outer surface of the protective cover that is in the forward direction of the light source, that is, a surface closer to an illuminated object, this part of the protective cover of the lighting system does not obstruct an electromagnetic wave radiated or received by the antenna. This helps to improve communication performance of the antenna.

It should be noted that, although an upper part of the translucent cover body L20 shown in FIG. 3-1 is a curved surface, and an upper part of the protection cover body L10 is a plane, it should be understood that this is only an example of an effect, and this embodiment of the present invention is not limited thereto. The upper part of the translucent cover body L20 may be a plane, and the upper part of the protection cover body L10 may be a curved surface, and the two can be combined in any form. In addition, the translucent cover body L20 does not necessarily protrude the protection cover body L10. Moreover, although the radiating element A10 shown in FIG. 3-1 is completely above the protection cover body L10, it should be understood that in this embodiment of the present invention, the radiating element A10 of the antenna may alternatively be embedded into the protection cover body L10 partially, or even may not protrude the protection cover body L10.

For example, referring to the side sectional view of a partial structure (L10, L20, and A10) of the antenna in this embodiment of the present invention shown in FIG. 3-2, an upper part of the translucent cover body L20 is a plane, and does not protrude the protection cover body L10; and the radiating element A10 is embedded into the protection cover body L10, and does not protrude the protection cover body L10 either. However, to reduce impact of the protection cover body L10 on a radiation characteristic, an effect is better if an upper surface of the radiating element A10 is not lower than an outer surface of the protection cover body L10.

FIG. 3-3 to FIG. 3-6 each are a top view of an overall structure of the antenna, and all the top views can be combined with the side view shown in FIG. 3-1, and show various feasible shapes of the radiating element A10 of the antenna in this embodiment of the present invention. Although the antennas shown in FIG. 3-3 to FIG. 3-6 are slightly different in shape, the antennas are still of a same type.

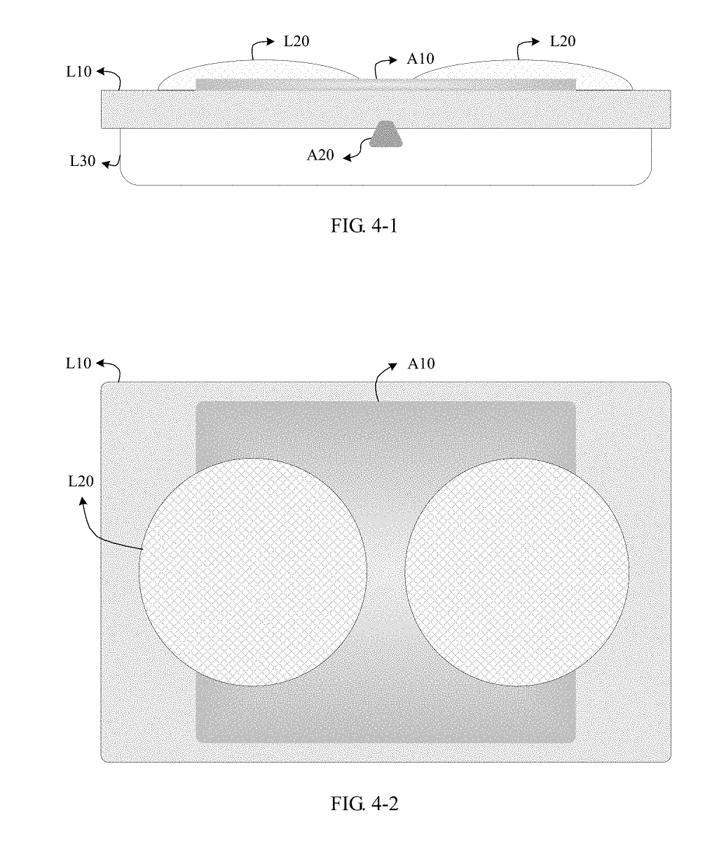

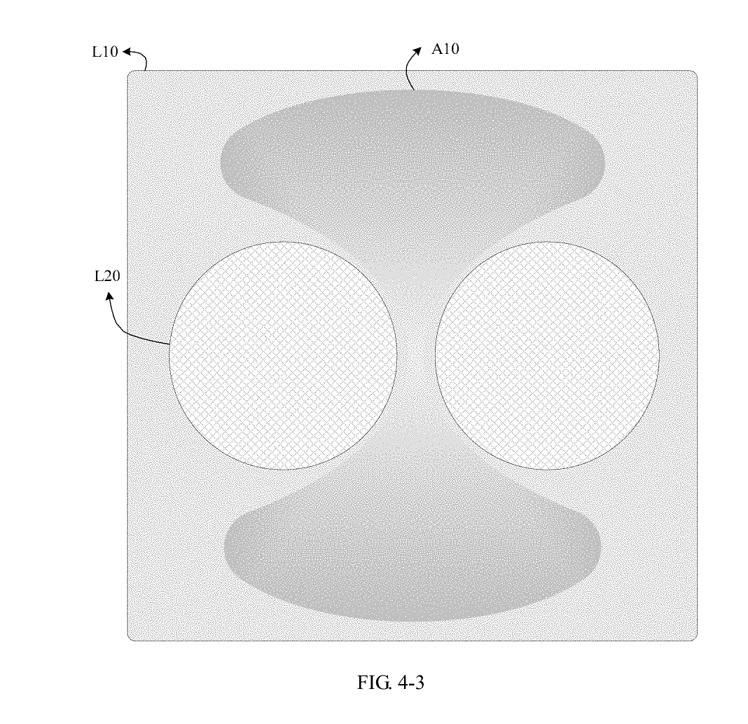

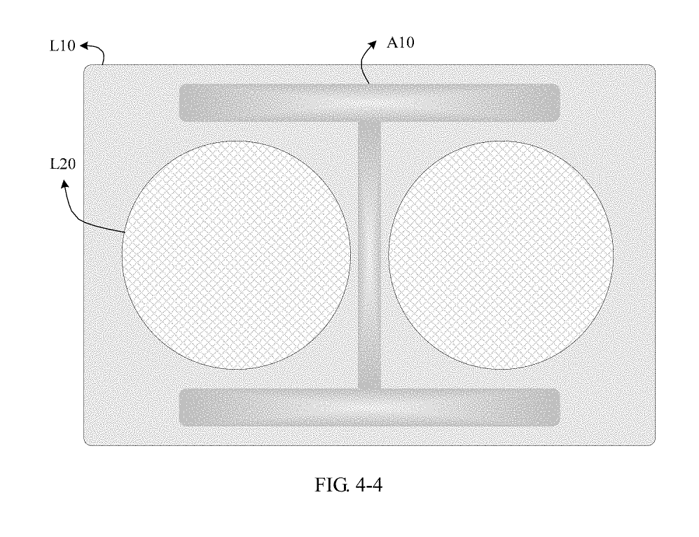

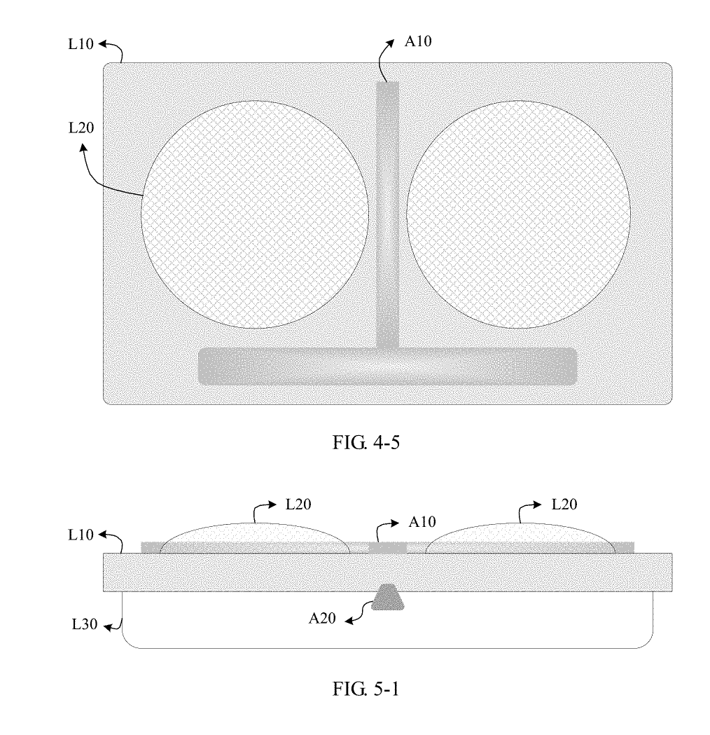

As shown in FIG. 3-3, an outer shape of the radiating element A10 is a rectangle, but a middle part is hollowed out according to a shape of the translucent cover body L20, and the translucent cover body L20 may be placed in the hollowed-out part, so that illuminating ray passes through. Similarly, as shown in FIG. 3-4, the radiating element A10 is in a shape of a rectangle formed by straight radiating bodies, and the translucent cover body L20 may be disposed inside the rectangle. As shown in FIG. 3-5, the radiating element A10 is in a shape of a ring formed by strip radiating bodies, and the translucent cover body L20 may be disposed inside the ring. In addition, as shown in FIG. 3-6, the protection cover body of the lighting system is in a shape of a circle.

Therefore, the radiating element A10 is disposed on the outer surface of the protective cover of the lighting system, and particularly on the outer surface of the protection cover body L10, without blocking the translucent cover body L20. Therefore, the radiating element A10 does not block the illuminating ray of the light source. According to the technical solutions, impact on an illumination effect of the lighting system is very small, and may be ignored.

It should be understood that, although FIG. 3-3 to FIG. 3-6 show some shapes of the protection cover body L10 and the radiating element A10, this embodiment of the present invention is not limited thereto. The protection cover body L10 may be in another shape, and there may also be various shape designs for the radiating element of the antenna, provided that the radiating element of the antenna does not block the translucent cover body L20. The shape of the radiating element of the antenna may be a polygon (a triangle, a rectangle, a pentagon, a hexagon to a dodecagon, or the like), a circle, an oval, a ring, a bow-tie shape, a petal shape, a regular shape (a cross shape, an H shape, a hollow square shape, a T shape, or the like) formed by strip metal bands or ring metal bands, or even another irregular shape.

As described above, in this embodiment of the present invention, a quantity of translucent cover bodies is not limited, and there may be one or more translucent cover bodies. FIG. 3-1 to FIG. 3-6 each show the structural feature of the antenna in this embodiment of the present invention, and particularly a structure of the radiating element of the antenna, when the lighting system includes one translucent cover body.

FIG. 4-1 to FIG. 4-5 each are a schematic structural diagram of an antenna according to an embodiment of the present invention, and each show an example of a structure of an antenna when a lighting system includes two translucent cover bodies. FIG. 5-1 to FIG. 5-4 each are also a schematic structural diagram of an antenna according to an embodiment of the present invention, and each show an example of a structure of an antenna when a lighting system includes four translucent cover bodies. FIG. 4-1 and FIG. 5-1 each are a side view of an overall structure of the antenna, and other accompanying drawings each are a top view of an overall structure of the antenna. Unless otherwise expressly stated, the accompanying drawings are not limited to representing an antenna of a single physical shape.

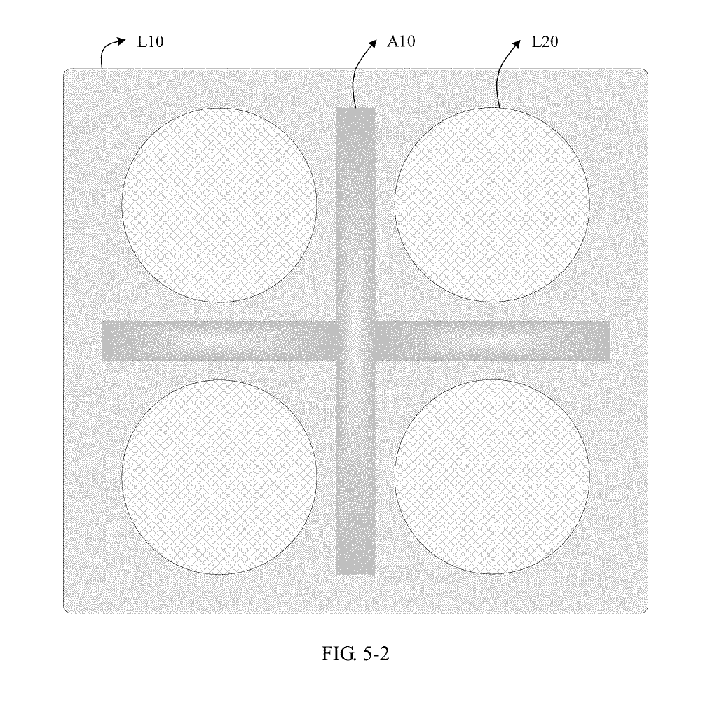

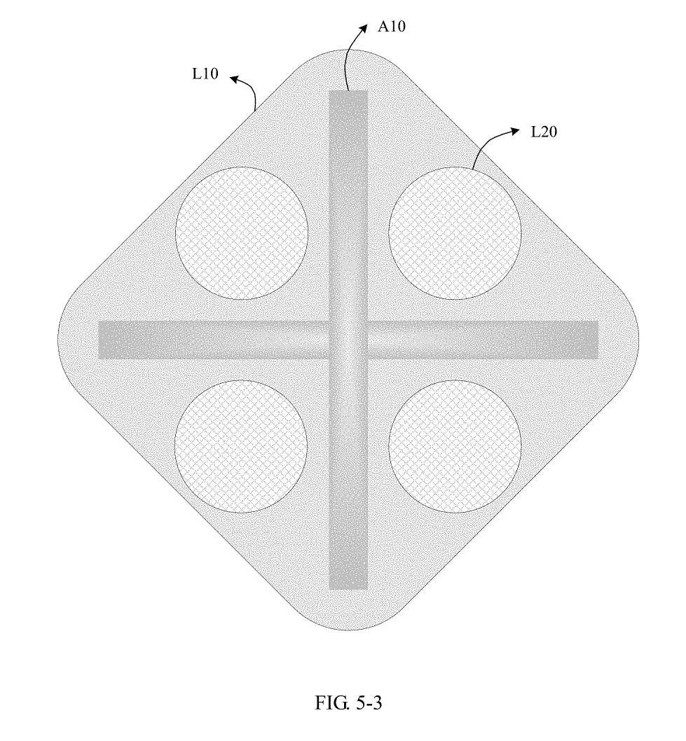

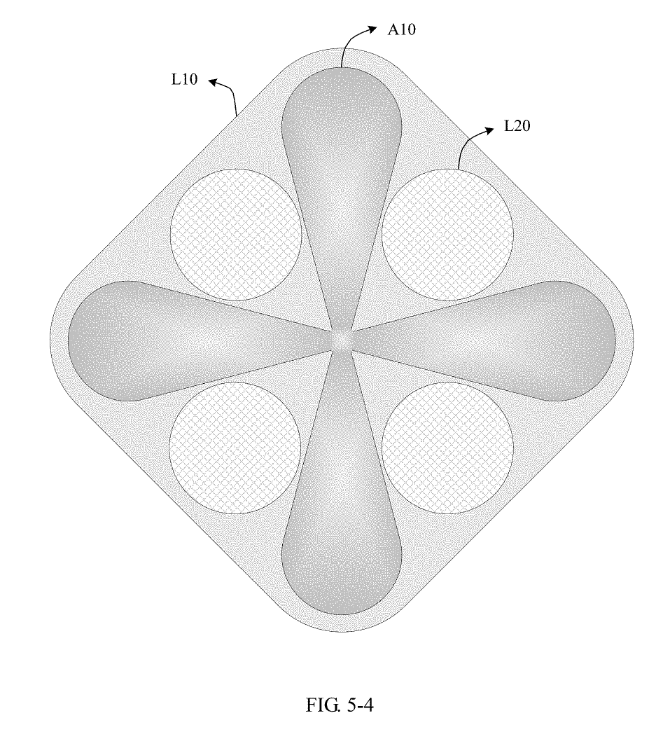

As shown in the accompanying drawings, a radiating element A10 is still disposed on an outer surface of a protection cover body L10, and does not block a translucent cover body L20. For example, an edge of a radiating element A10 shown in FIG. 4-2 is hollowed out, to avoid blocking the translucent cover body L20. A radiating element shown in FIG. 4-3 is in a bow tie shape, which can also be considered as a two-petal shape. A radiating element shown in FIG. 4-4 is in an H shape. A radiating element shown in FIG. 4-5 is in an inverted T shape. Radiating elements shown in FIG. 5-2 and FIG. 5-3 are in a cross shape. A radiating element shown in FIG. 5-4 is in a four-petal shape.

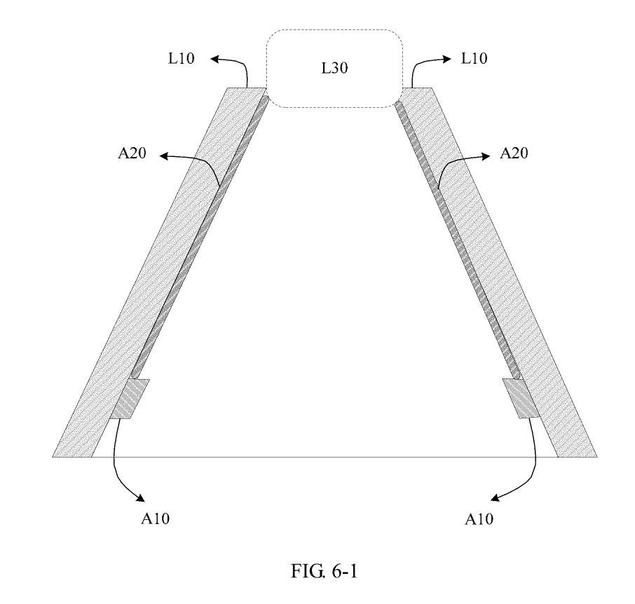

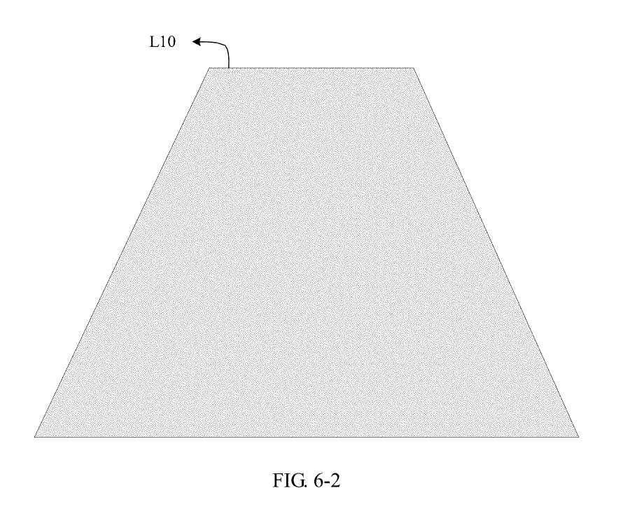

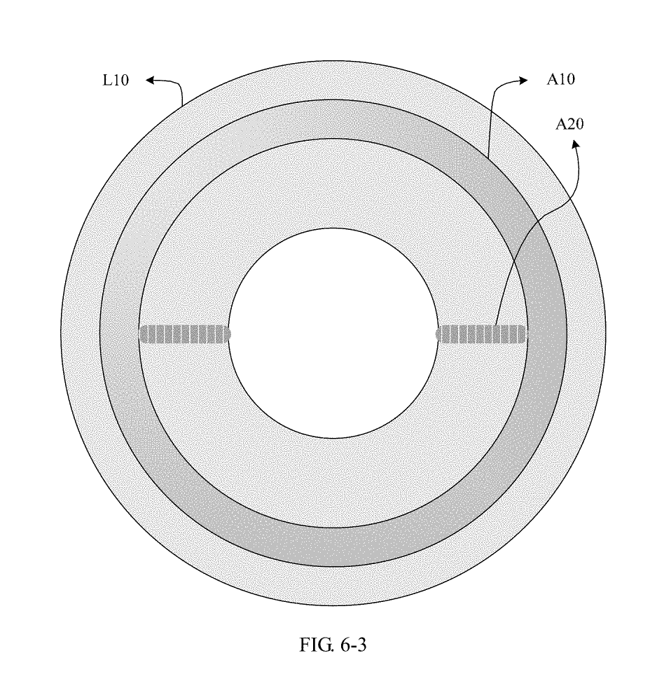

FIG. 6-1 to FIG. 6-3 each are a schematic structural diagram of an antenna according to an embodiment of the present invention. The antenna may be applied to the antenna deployment architecture shown in FIG. 2-2. FIG. 6-1 is a side sectional view of a partial structure of the antenna, FIG. 6-2 is a side view of an overall structure of the antenna, and FIG. 6-3 is a top view of an overall structure of the antenna with a viewing direction from an opening of a protective cover of a lighting system to a light source of the lighting system. With reference to the schematic structural diagrams, the following describes an inner structural feature of the antenna in the deployment architecture, and particularly a structural feature of a radiating element.

In FIG. 6-1, a module A10 represents a radiating element of the antenna, and is denoted as a radiating element A10. A module A20 represents a feeding unit of the antenna, and is denoted as a feeding unit A20. A module L10 represents a cover body of a lighting system, and the cover body is usually of a non-transparent material, and is denoted as a protection cover body L10. A module L30 represents other components of the antenna and the lighting system, for example, a power supply apparatus, a heat dissipation apparatus, a light source, a light distribution apparatus, and another cover body. For simplicity, the light source of the lighting system is not drawn separately.

As shown in FIG. 6-1, the radiating element A10 is disposed on an inner surface of the protection cover body L10. Because the radiating element of the antenna is disposed on an inner surface of a protective cover that is in a forward direction of the light source, that is, a surface closer to an illuminated object, this part of the protective cover of the lighting system does not obstruct an electromagnetic wave radiated or received by the antenna. This helps to improve communication performance of the antenna.

It can be learned with reference to FIG. 6-2 that, the radiating element of the antenna is on the inner surface of the protective cover of the lighting system, and a protection effect provided by the protective cover can be used, to improve durability of the antenna and ensure communication performance of the antenna. It can be learned with reference to FIG. 6-2 that, the radiating element of the antenna is attached to the inner surface of the protective cover of the lighting system, illuminating ray is essentially not blocked, and impact on an illumination effect of the lighting system is relatively small.

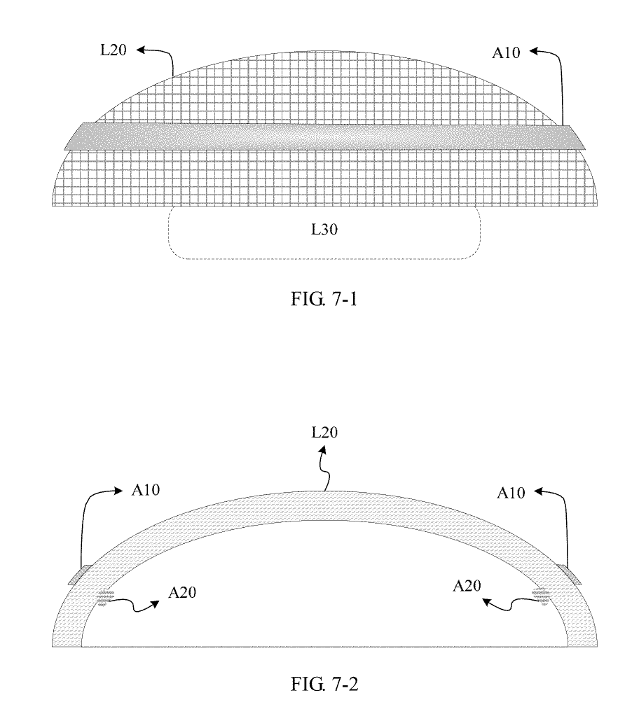

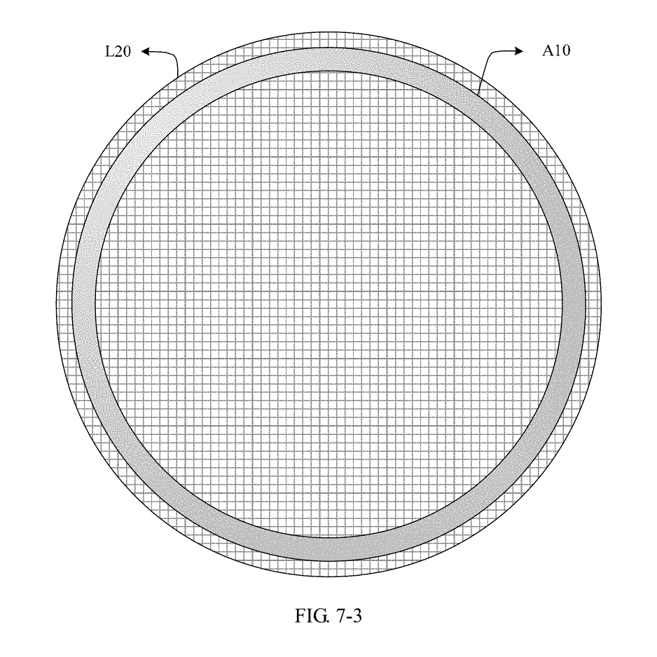

FIG. 7-1 to FIG. 7-3 each are a schematic structural diagram of an antenna according to an embodiment of the present invention. The antenna may be applied to the antenna deployment architecture shown in FIG. 2-3. FIG. 7-1 is a side view of an overall structure of the antenna, FIG. 7-2 is a side sectional view of a partial structure of the antenna, and FIG. 7-3 is a top view of an overall structure of the antenna. With reference to the schematic structural diagrams, the following describes a structural feature of the antenna in the deployment architecture, and particularly a structural feature of a radiating element.

In FIG. 7-1, a module A10 represents a radiating element of the antenna, and is denoted as a radiating element A10. A module L20 represents a cover body of a lighting system, and the cover body is of a transparent material, and is denoted as a translucent cover body L20. The translucent cover body L20 is also a part of a protective cover of the lighting system. A module L30 represents other components of the antenna and the lighting system, for example, a power supply apparatus, a heat dissipation apparatus, a light source, a light distribution apparatus, and another cover body. For simplicity, the light source of the lighting system is not drawn separately.

As shown in FIG. 7-1, the radiating element A10 is disposed on an outer surface of the translucent cover body L2. Because the radiating element of the antenna is disposed on an outer surface of a protective cover that is in a forward direction of the light source, that is, a surface closer to an illuminated object, this part of the protective cover of the lighting system does not obstruct an electromagnetic wave radiated or received by the antenna. This helps to improve communication performance of the antenna. It can be learned with reference to FIG. 7-2 and FIG. 7-3 that, the radiating element of the antenna is attached to the outer surface of the translucent cover body L20, and blocks illuminating ray to some extent. Therefore, compared with the foregoing two antenna structures, an illumination effect is affected to some extent.

It should be noted that, the antenna deployment position and structural feature are separately described above based on three types of antenna deployment architectures, and this is mainly for clear description. In the embodiments of the present invention, the antenna deployment positions and structural features described above should not be limited to be in only one antenna deployment architecture.

It should be understood that, based on description for the first two types of antenna deployment architectures, the antenna in the embodiments of the present invention, and particularly the radiating element of the antenna, may be integrated onto the inner surface or the outer surface of the protective cover of the lighting system, regardless of whether the cover body of the protective cover is a protection cover body or a translucent cover body. It can be learned based on description for the third type of antenna deployment architecture that, the antenna in the embodiments of the present invention, and particularly the radiating element of the antenna, not only can be integrated with the protection cover body, but also can be integrated with the translucent cover body.

In the embodiments of the present invention, a substrate of the antenna, which is also referred to a base on some occasions, may be located between the protective cover of the lighting system and the radiating element. In other words, there may be a separate substrate layer between the radiating element and the protective cover. For simplicity, the substrate layer is not particularly presented in the foregoing accompanying drawings. To further improve an integration level between the antenna and the lighting system, the substrate of the antenna may also be designed as being integrated with the protective cover of the lighting system.

In an optional solution, a part or a whole of the cover body of the protective cover of the lighting system is of a non-metal material, and the cover body of the non-metal material is disposed as the substrate of the antenna. In another optional solution, a dielectric layer of a non-metal material is attached to an outer surface of the protective cover of the lighting system, and the dielectric layer is disposed as the substrate of the antenna. The dielectric layer is located between the cover body of the protective cover and the radiating element of the antenna. In other words, the radiating element of the antenna is attached to an outer surface of the dielectric layer that is on the surface of the protective cover. According to the foregoing two solutions, the integration level between the antenna and the lighting system can be further improved. This helps to reduce an overall thickness of the protective cover and the substrate of the antenna, thereby reducing costs or improving performance.

In the embodiments of the present invention, one or more regularly arranged plated holes may be further disposed in the radiating element of the antenna and the protective cover of the lighting system. The plated hole, also referred to as a hole plated or a via hole, is a hole with an inner wall covered by a conducting metal layer, and is usually used for connection between a plurality of layers of printed wiring. With the plated hole, the radiating element is also grounded (electrically connected to a grounding plate), and generates one or more currents vertical to the radiating element, so that a radiation range of the antenna can be expanded. Therefore, the optional solution can be used to improve a radiation characteristic of the antenna, thereby improving communication performance of the antenna.

When a position of the plated hole is properly selected, omnidirectional radiation can even be formed. In a feasible implementation, a plurality of plated holes in the radiating element of the antenna and the protective cover of the lighting system are disposed on centrosymmetric edge positions of the radiating element.

In the embodiments of the present invention, an outer surface of the radiating element of the antenna may be further covered with a protection material. In other words, in another optional solution, one face of the radiating element of the antenna is attached to the surface of the protective cover, and the other face is covered with the protection material. The protection material may be used to provide a protection effect of physical isolation, thereby further improving durability of the antenna and ensuring communication performance of the antenna.

In the foregoing content of the embodiments of the present invention, the structural feature of the antenna, and particularly the structural feature of the radiating element of the antenna, has been described in detail based on the antenna deployment architectures and with reference to the accompanying drawings. In contrast, a structural feature of the feeding unit of the antenna is not described in detail. It should be understood that in the embodiments of the present invention, a basic function requirement on the feeding unit of the antenna is: being capable of transferring an electrical signal between the feeding unit and the radiating element. In other words, one part of the feeding unit of the antenna should support an electrical connection to the radiating element of the antenna, and the other part of the feeding unit supports an electrical connection to a signal processing device (which represents a signal source, such as a base station or a radio frequency processing unit). A feeding component using an existing feeding manner in the antenna field usually meets the basic function requirement. Therefore, a person skilled in the art may select an existing feeding component in the antenna field as the feeding unit in the embodiments of the present invention, and configure the feeding component in the lighting system.

However, to further improve the integration level between the antenna and the lighting system, in the embodiments of the present invention, there is an additional structure requirement on the feeding unit: a part of the feeding unit is integrated onto the protective cover of the lighting system. As shown in the foregoing schematic structural diagrams (FIG. 3-1, FIG. 4-1, FIG. 5-1, FIG. 6-1, and FIG. 7-1) of the antenna, the feeding unit A20 partially overlaps the protective cover of the lighting system, and this indicates that a part of the feeding unit is integrated onto the protective cover of the lighting system. The feeding unit part that is integrated onto the protective cover of the lighting system and the radiating element that is integrated onto the protective cover can be designed and manufactured as a whole more conveniently. Therefore, such a technical solution helps to further improve the integration level between the antenna and the lighting system, reduce manufacturing, deployment or maintenance costs of the antenna, and even improve performance of the antenna.

To provide more details about the structural feature of the antenna in the embodiments of the present invention, and particularly the structural feature of the feeding unit, the following provides further description with reference to accompanying drawings.

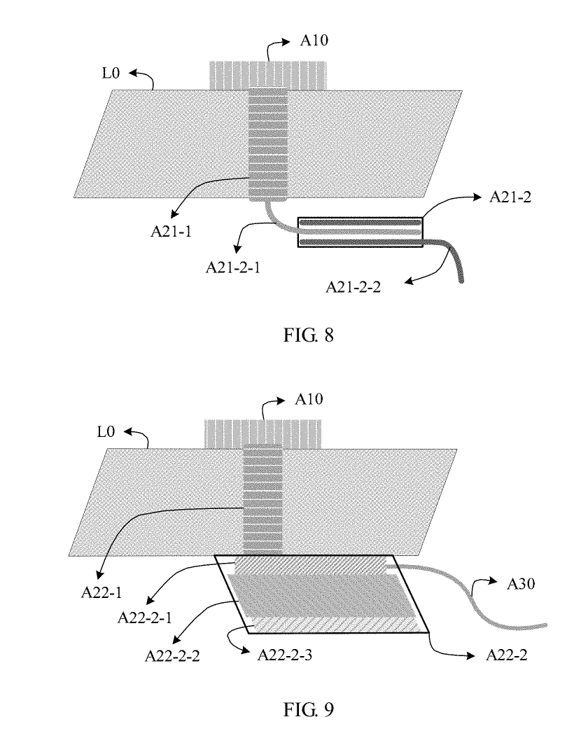

FIG. 8 is a schematic structural diagram of a feeding manner of an antenna according to an embodiment of the present invention, and the schematic structural diagram is a side sectional view of a partial structure of the antenna. In FIG. 8, a module L0 represents a cover body of a protective cover of a lighting system, and is denoted as a cover body L0. The cover body L0 may be a protection cover body or a translucent cover body. A module A10 represents a radiating element of the antenna, and is denoted as a radiating element A10.

A module A21-1 and a module A21-2 each represent a part of a feeding unit of the antenna. The module A21-1 is a metal conductor, and is denoted as a metal conductor A21-1. The metal conductor A21-1 may be a metal probe, a metal sheet, or a plated hole. The module A21-2 is a coaxial line, and is denoted as a coaxial line A21-2, where a module A21-2-1 represents an inner conductor of the coaxial line, and is denoted as an inner conductor A21-2-1, and a module A21-2-2 represents an outer conductor of the coaxial line, and is denoted as an outer conductor A21-2-2.

As shown in FIG. 8, the radiating element A10 is attached to a surface of the cover body L0. There is a gap on the surface of the cover body L0, a main body part of the metal conductor A21-1 is embedded into the gap of the cover body L0, one end is in direct contact with the radiating element A10, and the other end is connected to the inner conductor A21-2-1.

When the antenna is in a working state, the coaxial line A21-2 is connected to a signal processing device. The inner conductor A21-2-1 of the coaxial line is electrically connected to the signal processing device, to transfer an electrical signal of the antenna. The outer conductor A21-2-2 of the coaxial line may be grounded, to shield interference. For example, when the antenna is in a transmission state, the coaxial line A21-2 receives, from the signal processing device, an electrical signal to be sent by the antenna, and feeds the electrical signal to the radiating element A10 by using the metal conductor A21-1, and the radiating element A10 radiates the electrical signal to space in an electromagnetic wave form.

The signal processing device may be a base station or a radio frequency processing device in a mobile communications network. The radio frequency processing device may be a remote radio unit (RRU) or a remote radio head (RRH).

Therefore, the antenna structure shown in FIG. 8 may be used to integrate a part (A21-1) of the feeding unit of the antenna onto the protective cover of the lighting system, to improve an integration level between the antenna and the lighting system.

In an optional implementation, the radiating element A10 of the antenna is attached to one surface of the cover body L0, a groove is disposed in the other surface, and the coaxial line A21-2 is arranged in the groove. This helps to fasten the coaxial line, and further improve the integration level between the antenna and the lighting system.

FIG. 9 is a schematic structural diagram of another feeding manner of an antenna according to an embodiment of the present invention, and the schematic structural diagram is a side sectional view of a partial structure of the antenna. Similar to FIG. 8, a module L0 in FIG. 9 represents a cover body of a protective cover of a lighting system, and is also denoted as a cover body L0; and a module A10 represents a radiating element of the antenna, and is also denoted as a radiating element A10.

A module A22-1 and a module A22-2 each represent a part of a feeding unit of the antenna. The module A22-1 is a metal conductor, and is denoted as a metal conductor A22-1. For example, the metal conductor A22-1 may be a metal conductor in different shapes, such as a metal probe, a metal slice, or a plated hole. The module A22-2 represents a feeding panel, is denoted as a feeding panel A22-2, and includes a signal layer A22-2-1 and a dielectric layer A22-2-2. Optionally, the feeding panel A22-2 further includes a ground plane A22-2-3. In this embodiment of the present invention, a basic requirement for the signal layer and the ground plane in the feeding panel is that the signal layer and the ground plane are electrical conductors, and a basic requirement for the dielectric layer is that the dielectric layer is a nonconductor.

A module A30 represents a signal cable, and is denoted as a signal cable 30. It should be understood that, the signal cable 30 is different from the signal layer A22-2-1. The signal cable 30 is a conducting wire that is configured to transfer an electrical signal between the signal layer A22-2-1 and a signal processing device, may also be referred to as a feeder line, and includes cables such as a coaxial line, a waveguide, and a parallel double-line transmission line. Although the signal cable 30 is necessary in many scenarios, and may be considered as a part of the feeding unit, the signal cable 30 is not a part of the feeding panel A22-2. The signal cable 30 is mainly used in a scenario in which an electrical signal of the antenna cannot be directly transferred between the feeding panel A22-2 and the signal processing device. Therefore, even if the feeding unit includes the signal cable, the signal cable can be decoupled from the feeding panel that is integrated onto the protective cover of the antenna. This helps to improve antenna design flexibility, and improve engineering structure stability of the antenna.

As shown in FIG. 9, the radiating element A10 is attached to one surface of the cover body L0, and the feeding panel A22-2 is attached to the other surface of the cover body L10. The metal conductor A22-1 is placed into the cover body L0, one end of the metal conductor A22-1 is in direct contact with the radiating element A10, and the other end is in direct contact with the signal layer A22-2-1 of the feeding panel. The signal layer A22-2-1 of the feeding panel is disposed on one surface of the dielectric layer A22-2-2, and the dielectric layer A22-2-2 provides functions of supporting and isolation. When the feeding panel A22-2 further includes the ground plane A22-2-3, the ground plane A22-2-3 is disposed on the other surface of the dielectric layer A22-2-2.

When the antenna is in a working state, the signal layer A22-2-1 of the feeding panel is electrically connected to the signal processing device (by using the signal cable 30). When the feeding panel A22-2 further includes the ground plane A22-2-3, the ground plane A22-2-3 is grounded. This also delivers an effect of shielding interference.

Therefore, the antenna structure shown in FIG. 9 may be used to integrate both the metal conductor A22-1 and the feeding panel A22-2 of the feeding unit of the antenna onto the protective cover of the lighting system, to improve an integration level between the antenna and the lighting system.

It should be noted that, in the antenna structure shown in FIG. 9, the feeding panel A22-2 is only a schematic structure, and is not a unique implementation of the present invention. In application, a common example of the schematic structure is a microstrip, but this embodiment of the present invention is not uniquely limited to the microstrip, and another signal transmission line that conforms to the schematic structure and textual description should also be included in this embodiment of the present invention.

In addition, with reference to the antenna structures shown in FIG. 8 and FIG. 9, in an optional implementation, the metal conductors (A21-1 and A22-2) are embedded into the cover body L10 at an angle vertical to or nearly vertical to the radiating element. This can help to implement feeding in a vertical structure, and improve a radiation characteristic of the antenna. In addition, the metal conductor may be in a gradually-changed shape such as a trapezoid, and a cross sectional area of the conductor increases along a direction from the coaxial line or the microstrip to the radiating element. This helps to improve performance of the antenna.

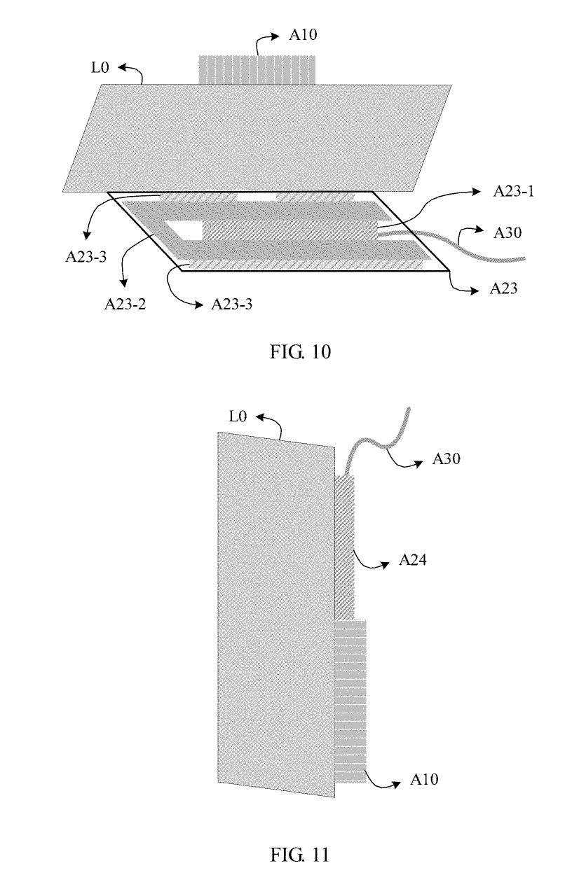

FIG. 10 is a schematic structural diagram of still another feeding manner of an antenna according to an embodiment of the present invention, and the schematic structural diagram is a side sectional view of a partial structure of the antenna. Similarly, a module L0 represents a cover body of a protective cover of a lighting system, and is denoted as a cover body L0. A module A10 represents a radiating element of the antenna, and is denoted as a radiating element A10. A module A30 represents a signal cable, and is also denoted as a signal cable 30.

In addition, a module A23 represents another feeding panel, is denoted as a feeding panel A23, and includes a signal layer A23-1, a dielectric layer A23-2, and (two) ground planes A23-3. As shown in the figure, the radiating element A10 is attached to one surface of the cover body L0, and the feeding panel A23 is attached to the other surface of the cover body L10. In the feeding panel A23, a ground plane A23-3 is disposed on each of two surfaces of the dielectric layer A23-2, where there is a gap in a surface of the ground plane A23-3 that is attached to the cover body L0. The signal layer A23-1 is disposed inside the dielectric layer A23-2.

When the antenna is in a working state, the signal layer A23-1 of the feeding panel is electrically connected to a signal processing device (by using the signal cable 30), and the ground planes A23-3 are grounded. For example, when the antenna is in a transmission state, the signal layer A23-1 receives, from the signal processing device, an electrical signal to be sent by the antenna, and couples the electrical signal to the radiating element A10 through the dielectric layer and the gap on the ground plane A23-3, and the radiating element A10 radiates the electrical signal to space in an electromagnetic wave form.

Therefore, the antenna structure shown in FIG. 10 may be used to integrate the feeding panel A23 of the feeding unit of the antenna onto the protective cover of the lighting system, to improve an integration level between the antenna and the lighting system.

In application, a common example of the schematic structure is a stripline, but this embodiment of the present invention is not uniquely limited to the stripline, and another signal transmission line that conforms to the schematic structure and textual description should also be included in this embodiment of the present invention.

FIG. 11 is a schematic structural diagram of yet another feeding manner of an antenna according to an embodiment of the present invention, and the schematic structural diagram is a side sectional view of a partial structure of the antenna. Similarly, a module L0 represents a cover body of a protective cover of a lighting system, and is denoted as a cover body L0. A module A10 represents a radiating element of the antenna, and is denoted as a radiating element A10. A module A30 represents a signal cable, and is also denoted as a signal cable 30.

In addition, A24 represents a part of a feeding unit of the antenna, and is denoted as a feeding metal strip A24. In application, the feeding metal strip may be a microstrip. In addition, to improve an integration level, the cover body L0 may act as a dielectric layer of the microstrip. As shown in the figure, both the feeding metal strip A24 and the radiating element A10 are disposed on a same surface of the cover body L0, and are in direct contact. FIG. 6-1 and FIG. 6-3 also show this point.

When the antenna is in a working state, the feeding metal strip A24 is electrically connected to a signal processing device (by using the signal cable 30). Therefore, the antenna structure shown in FIG. 11 may be used to integrate the feeding metal strip A24 of the feeding unit of the antenna onto the protective cover of the lighting system, to improve an integration level between the antenna and the lighting system.

In contrast, a separate feeding panel is not required in the feeding unit in the antenna structure shown in FIG. 8. This helps to reduce overall dimensions of the antenna. Herein, the feeding unit can be in direct contact with the radiating element by using the metal conductor embedded into the protective cover of the lighting system. This helps to ensure a feeding effect, and improve performance of the antenna. Although a separate feeding panel is used in the feeding units in the antenna structures shown in FIG. 9 and FIG. 10, the feeding panel can be decoupled from the signal cable. This helps to improve antenna design flexibility, and improve engineering structure stability of the antenna. In addition, in the antenna structure shown in FIG. 10, the feeding unit performs feeding to the radiating element in a coupling manner, and in the antenna structure shown in FIG. 11, the feeding unit and the radiating element are located on a same surface of the protective cover. Therefore, in both the technical solutions, trepanning or slotting on the protective cover is not required. This helps to reduce production costs, and improve engineering structure stability of the antenna.

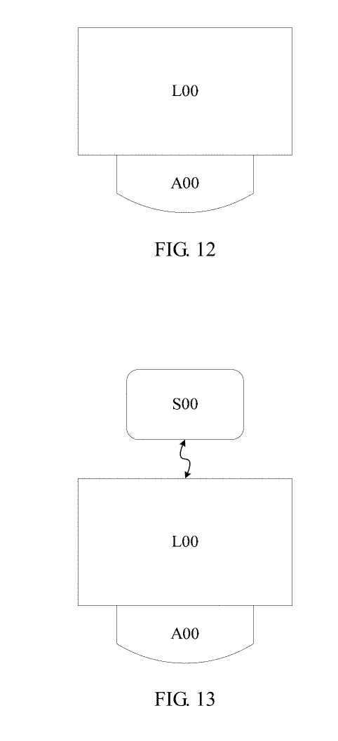

In the embodiments of the present invention, there is a lighting system in addition to the antenna. FIG. 12 is a schematic structural diagram of a lighting system according to an embodiment of the present invention. A module L00 represents a lighting sub-system, and is denoted as a lighting sub-system L00. The lighting sub-system may be the foregoing lighting system that is used as an antenna-integrated architecture. A module A00 represents an antenna, and is denoted as an antenna A00. The antenna A00 is integrated into the lighting sub-system L00 (in FIG. 12, an integration relationship is represented by abutting positions of the modules), to form the lighting system in this embodiment of the present invention together. For further structural features of the lighting sub-system and the antenna, refer to the foregoing accompanying drawings and textual description. Details are not described herein again.

An embodiment of the present invention further provides a communications system. FIG. 13 is a schematic structural diagram of a communications system according to an embodiment of the present invention. A module L00 represents a lighting sub-system, and is denoted as a lighting sub-system L00; a module A00 represents an antenna, and is denoted as an antenna A00; and a module S00 represents a signal processing device, and is denoted as a signal processing device S00. The communications system includes the signal processing device S00 and the antenna A00. As shown in the figure, by using a cable, the signal processing device is electrically connected to the antenna that is integrated into the lighting sub-system L00. For further structural features of the signal processing device and the antenna, refer to the foregoing accompanying drawings and textual description. Details are not described herein again.

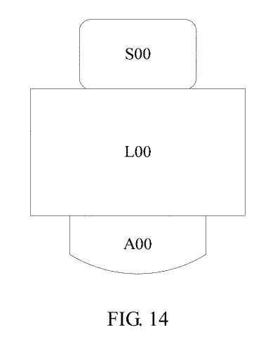

An embodiment of the present invention further provides a communications system. FIG. 14 is a schematic structural diagram of a communications system according to an embodiment of the present invention. A module L00 represents a lighting sub-system, and is denoted as a lighting sub-system L00; a module A00 represents an antenna, and is denoted as an antenna A00; and a module S00 represents a signal processing device, and is denoted as a signal processing device S00. The communications system includes the signal processing device S00 and the lighting sub-system L00. As shown in the figure, the signal processing device is also integrated into the lighting sub-system L00, and is electrically connected to the antenna A00 that is integrated into the lighting sub-system. For further structural features of the signal processing device and the antenna, refer to the foregoing accompanying drawings and textual description. Details are not described herein again.

In application, the signal processing device may be a radio frequency processing unit used for mobile communication. To integrate the signal processing device into the lighting sub-system, space may be reserved in the protective cover, to accommodate the signal processing device. Alternatively, the signal processing device may be integrated with another module of the lighting sub-system, for example, a module such as a lamp post with a relatively large designed space margin.

With reference to a context, terms “network” and “system” are interchangeable with each other on some occasions. The term “and/or” is used to describe an association relationship of associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that, the foregoing descriptions are merely specific implementations of the present application, but are not intended to limit the protection scope of the present application. The foregoing antenna, lighting system, and communications system may also be implemented in another equivalent manner. For example, the foregoing antenna, lighting system, and communications system shown in the schematic structural diagrams are merely logical function division, and there may be another physical division manner during specific implementation. For example, a plurality of logical modules are embodied as one physical module, or one physical module is split into a plurality of physical modules. A person of ordinary skill in the art easily thinks of various equivalent modifications or replacements, and all the modifications and replacements should belong to the technical scope disclosed in the present application.

1. An antenna, comprising a radiating element and a feeding unit, wherein the radiating element is configured to perform conversion between an electromagnetic wave in space and an electrical signal in a circuit, and wherein the feeding unit is configured to transfer the electrical signal between the feeding unit and the radiating element;
wherein the antenna is integrated with a lighting system, and wherein the lighting system comprises a protective cover and a light source disposed inside the protective cover; and
wherein both the radiating element and the feeding unit of the antenna are integrated with the protective cover of the lighting system, wherein the radiating element is attached to a surface of a cover body, in a forward direction of the light source, of the protective cover, wherein one part of the feeding unit is integrated with the protective cover, and is electrically connected to the radiating element, and wherein the other part of the feeding unit supports an electrical connection to a signal processing device.

2. The antenna according to claim 1, wherein part of the cover body to which the radiating element is attached is of a non-conductive material, and is disposed as a substrate of the antenna.

3. The antenna according to claim 1, wherein:
the feeding unit comprises a feeding metal conductor, a gap exists in the cover body to which the radiating element is attached, and the feeding metal conductor is disposed in the gap; and
the feeding metal conductor passes through the cover body via the gap, one end of the feeding metal conductor is in direct contact with the radiating element, and the other end of the feeding metal conductor supports an electrical connection to a signal transmission line, wherein the signal transmission line is configured to transmit an electrical signal between the feeding metal conductor and the signal processing device.

4. The antenna according to claim 3, wherein:
the feeding metal conductor is a feeding metal sheet, the signal transmission line is a coaxial line, and the coaxial line comprises an outer conductor and an inner conductor that are coaxial, wherein:
the outer conductor of the coaxial line is used for grounding, one end of the inner conductor of the coaxial line is in direct contact with the feeding metal sheet, and the other end of the inner conductor of the coaxial line supports the electrical connection to the signal processing device.

5. The antenna according to claim 3, wherein:
the feeding metal conductor is a feeding metal sheet, the signal transmission line is a microstrip, and the microstrip comprises a signal layer, a dielectric layer, and a ground plane that are sequentially attached, wherein:
the ground plane of the microstrip is used for grounding, the signal layer of the microstrip comprises a conductor strip, one end of the conductor strip is in direct contact with the feeding metal sheet, and the other end of the conductor strip supports the electrical connection to the signal processing device.

6. The antenna according to of claim 3, wherein the feeding metal conductor is of an axisymmetric structure, and wherein the feeding metal conductor is disposed in the gap at an angle at which a central axis is vertical to the radiating element.

7. The antenna according to claim 1, wherein:
the feeding unit comprises a feeding panel, and the feeding panel is disposed on the other surface of the cover body to which the radiating element is attached, wherein:
the feeding panel comprises a dielectric layer, a ground plane is attached to each of two surfaces of the dielectric layer, and a gap exists in the ground plane that is close to the radiating element; and
the dielectric layer comprises a conductor strip, one end of the conductor strip abuts the gap, and the other end of the conductor strip supports the electrical connection to the signal processing device.

8. The antenna according to claim 1, wherein the radiating element is attached to an inner surface of the cover body of the protective cover that is in the forward direction of the light source, wherein the feeding unit comprises a conductor strip, and is also attached to the inner surface of the cover body, wherein one end of the conductor strip is in direct contact with the radiating element, and wherein the other end of the conductor strip supports the electrical connection to the signal processing device.

9. The antenna according to claim 1, wherein an inside or an edge of the radiating element is hollowed out, and wherein illuminating ray of the light source passes through a hollowed-out part.

10. The antenna according to claim 1, wherein at least one plated hole is further disposed in the radiating element, and wherein a conducting metal layer covers an inner wall of the plated hole, and is used for grounding of the radiating element.

11. The antenna according to claim 10, wherein:
the radiating element is in a regular geometric shape with a geometric center; and
a plurality of plated holes are disposed in the radiating element, and the plurality of plated holes are symmetrically distributed around the geometric center of the radiating element.

12. The antenna according to claim 1, wherein the antenna is integrated into the lighting system in which a light emitting diode is used as the light source, and shares a heat dissipation apparatus with the lighting system.

13. The antenna according to claim 1, wherein the feeding unit of the antenna comprises a communications interface that is configured to support the electrical connection to the signal processing device, and wherein the signal processing device is a radio frequency processing unit used for mobile communication.

14. A lighting system, comprising lighting sub-systems and an antenna, wherein the lighting sub-system comprises a protective cover and a light source disposed inside the protective cover, and wherein the antenna comprises a radiating element and a feeding unit;
wherein the feeding unit of the antenna is integrated onto the protective cover of the lighting system; and
wherein the radiating element of the antenna is attached to a surface of a cover body, in a forward direction of the light source, of the protective cover of the lighting system, and wherein part of the cover body to which the radiating element is attached is of a non-conductive material, and is disposed as a substrate of the antenna.

15. The lighting system according to claim 14, wherein:
a gap exists in the cover body of the protective cover, the gap is configured to arrange a feeding metal conductor, a signal transmission line is attached to an inner surface of the protective cover, and both the feeding metal conductor and the signal transmission line belong to the feeding unit of the antenna, wherein:
the feeding metal conductor passes through the cover body via the gap, one end of the feeding metal conductor is in direct contact with the radiating element, and the other end of the feeding metal conductor is in direct contact with the signal transmission line.

16. The lighting system according to claim 14, wherein:
a feeding panel is disposed on the other surface of the cover body to which the radiating element is attached, and the feeding panel belongs to the feeding unit of the antenna, wherein:
the feeding panel comprises a dielectric layer, a ground plane is attached to each of two surfaces of the dielectric layer, and a gap exists in the ground plane that is close to the radiating element; and
the dielectric layer comprises a conductor strip, one end of the conductor strip abuts the gap, and the other end of the conductor strip supports an electrical connection to a signal processing device.

17. The lighting system according to claim 14, wherein the radiating element and the feeding unit of the antenna are attached to an inner surface of the cover body of the protective cover that is in the forward direction of the light source, wherein the feeding unit comprises a conductor strip, wherein one end of the conductor strip is in direct contact with the radiating element, and wherein the other end of the conductor strip supports an electrical connection to a signal processing device.

18. The lighting system according to claim 14, wherein at least one plated hole is further disposed in the cover body to which the radiating element is attached, and wherein a conducting metal layer covers an inner wall of the plated hole, and is used for grounding of the radiating element.

19. The lighting system according to claim 14, wherein a light source of the lighting sub-system is a light emitting diode, and wherein the lighting sub-system shares a heat dissipation apparatus with the antenna.

20. A communications system, comprising an antenna and a signal processing device, wherein:
the antenna is integrated with a lighting system, wherein the lighting system comprises a protective cover and a light source disposed inside the protective cover; and
both a radiating element and a feeding unit of the antenna are integrated with the protective cover of the lighting system, wherein the radiating element is attached to a surface of a cover body, in a forward direction of the light source, of the protective cover, wherein one part of the feeding unit is integrated with the protective cover, and is electrically connected to the radiating element, and wherein the other part of the feeding unit is electrically connected to the signal processing device.
